(19) United States
(12) Patent Application Publication
(10) Pub. No.: US 2026/0016778 A1
(43) Pub. Date: Jan. 15, 2026

(54) IMAGE FORMING APPARATUS

(71) Applicant: CANON KABUSHIKI KAISHA, Tokyo (JP)

(72) Inventors: TAKURO MITA, Kanagawa (JP); YASUHISA MATSUMOTO, Shizuoka (JP)

(21) Appl. No.: 19/256,644

(22) Filed: Jul. 1, 2025

(30) Foreign Application Priority Data
Jul. 11, 2024 (JP) 2024-112005

(51) Int. Cl. G03G 15/23; G03G 15/00; G03G 15/01; G03G 15/16

(52) U.S. Cl. CPC G03G 15/234; G03G 15/0131; G03G 15/0189; G03G 15/1675; G03G 15/168; G03G 15/50; G03G 15/6579; G03G 2215/00725

(57) ABSTRACT

A controller is capable of executing a first operation when a predetermined condition is not satisfied, and a second operation when the predetermined condition is satisfied. The predetermined condition includes at least one of that an environmental temperature is a predetermined temperature or more, that a remaining lifetime of a developing device is less than a predetermined value, that a user designates the second operation, that an image density in the immediately-before printing is a predetermined value or more, that an image in the immediately-before printing includes an image other than a text image, and that a maximum density of a part of a region in immediately-before printing is a predetermined value or more. When detection that there is no sheet corresponding to the objective sheet is made by a detecting portion, a toner image formed by the second operation is transferred onto a re-conveying sheet.

### BACKGROUND

### Field of the Technology

The present disclosure relates to an image forming apparatus. For example, the present disclosure relates to an image forming apparatus using an electrophotographic type or an electrostatic type and relates to an image forming apparatus including a switchback mechanism for reversing a sheet conveying direction for double-sided printing.

### Description of the Related Art

In recent years, a wide variety of types are proposed and realized as a sheet conveying type for sending a sheet to an image forming portion in an electrophotographic image forming apparatus. As one of the types, there is a so-called automatic double-sided conveying function enabling formation of images on both surfaces of a sheet reversed automatically without setting a front surface (side) and a back surface (side) of the sheet again by a user.

Further, of image forming apparatuses including an intermediary transfer member and having the automatic double-sided conveying function, there is the image forming apparatus in which a sheet on which printing on one surface is ended and waits inside a double-sided unit and in which printing on a back surface of the waiting sheet is made after printing is made on one surface of the fed sheet.

In such an image forming apparatus, when the sheet is absent in a sheet feeding portion during execution of a double-sided print job, there is a case where on an intermediary transfer member, a toner image for which there is no corresponding sheet and a toner image corresponding to the waiting sheet in the double-sided unit are formed. Here, of the toner images formed on the intermediary transfer member, the toner image for which there is no corresponding sheet is referred to as a “sheet-less toner image”.

The sheet-less toner image is deposited on a secondary transfer roller when the sheet-less toner image passes through a secondary transfer portion, and then contamination of a back surface (side) of the sheet, fed from the double-sided unit, with the toner deposited on the secondary transfer roller occurs in some cases. Hereinafter, this contamination is referred to as backside contamination.

In order to prevent such backside contamination, in Japanese Laid-Open Patent Publication No. 2006-215369, the following technique is disclosed. That is, at a timing when the sheet-less toner image passes through the secondary transfer portion, a voltage opposite in polarity to a voltage applied when an image is transferred onto the sheet is applied. By this, the toner deposited on the secondary transfer roller is put in an allowable range, so that the backside contamination of the sheet is put within an allowable range.

### SUMMARY

The present disclosure is directed to suppress a lowering in productivity during double-sided printing.

In order to solve this problem, the present disclosure includes the following constitutions.

According to an aspect of the present disclosure, there is provided an image forming apparatus comprising: an image bearing member; an intermediary transfer member onto which a toner image formed on the image bearing member is transferred; a transfer member configured to transfer the toner image, transferred on the intermediary transfer member, onto a sheet, the transfer member forming a transfer nip between the intermediary transfer member and the transfer member; an accommodating portion configured to accommodate the sheet; a detecting portion configured to detect presence or absence of the sheet in the accommodating portion; a double-sided conveying path through which the sheet which has a front surface on which an image is formed, and which is conveyed toward the transfer nip passes; and a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member, wherein the controller is capable of executing a first operation in which the back surface printing is performed with a first interval from the immediately-before printing and a second operation in which the back surface printing is performed with a second interval longer than the first interval from the immediately before printing, wherein the controller is capable of executing the first operation in a case where a predetermined condition is not satisfied, and is capable of executing the second operation in a case where the predetermined condition is satisfied, wherein the predetermined condition includes at least one of that an environmental temperature is a predetermined temperature or more, that a remaining lifetime of a developing device is less than a predetermined value, that a user designates the second operation, that an image density in the immediately-before printing is a predetermined value or more, that an image in the immediately-before printing includes an image other than a text image, and that a maximum density of a part of a region in the immediately-before printing is a predetermined value or more, and wherein in a case where detection that there is no sheet corresponding to the objective sheet is made by the detecting portion, the toner image formed by the second operation is transferred onto the re-conveying sheet.

According to another aspect of the present disclosure, there is provided an image forming apparatus comprising: an image bearing member; an intermediary transfer member onto which a toner image formed on the image bearing member is transferred; a transfer member configured to transfer the toner image, transferred on the intermediary transfer member, onto a sheet, the transfer member forming a transfer nip between the intermediary transfer member and the transfer member; an accommodating portion configured to accommodate the sheet; a detecting portion configured to detect presence or absence of the sheet in the accommodating portion; a double-sided conveying path through which the sheet which has a front surface on which an image is formed, and which is conveyed toward the transfer nip passes; and a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member, wherein the controller is capable of executing a first operation in which the back surface printing is performed with a first interval from the immediately-before printing and a second operation in which the back surface printing is performed with a second interval longer than the first interval from the immediately before printing, wherein the controller is capable of executing the first operation in a case where a predetermined condition is not satisfied, and is capable of executing the second operation in a case where the predetermined condition is satisfied, and wherein in a case where detection that there is no sheet corresponding to the objective sheet is made by the detecting portion, an amount of toner deposited on the transfer member by passing, through the transfer nip, of the toner image formed in the immediately-before printing is larger when the predetermined condition is satisfied than when the predetermined condition is not satisfied.

According to another aspect of the present disclosure, there is provided an image forming apparatus comprising: an image bearing member; an intermediary transfer member onto which a toner image formed on the image bearing member is transferred; a transfer member configured to transfer the toner image, transferred on the intermediary transfer member, onto a sheet, the transfer member forming a transfer nip between the intermediary transfer member and the transfer member; an accommodating portion configured to accommodate the sheet; a detecting portion configured to detect presence or absence of the sheet in the accommodating portion; a double-sided conveying path through which the sheet which has a front surface on which an image is formed, and which is conveyed toward the transfer nip passes; and a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member, wherein the controller is capable of executing a first operation in which the back surface printing is performed with a first interval from the immediately-before printing and a second operation in which the back surface printing is performed with a second interval longer than the first interval from the immediately before printing, wherein the controller is capable of executing the first operation in a case where there is no designation of the second operation by the user, and is capable of executing the second operation in a case where there is the designation, and wherein in a case where detection that there is no sheet corresponding to the objective sheet is made by the detecting portion, the toner image formed by the second operation is transferred onto the re-conveying sheet.

According to another aspect of the present invention, there is provided an image forming apparatus comprising: an image bearing member; an intermediary transfer member onto which a toner image formed on the image bearing member is transferred; a transfer member configured to transfer the toner image, transferred on the intermediary transfer member, onto a sheet, the transfer member forming a transfer nip between the intermediary transfer member and the transfer member; an accommodating portion configured to accommodate the sheet; a detecting portion configured to detect presence or absence of the sheet in the accommodating portion; a double-sided conveying path through which the sheet which has a front surface on which an image is formed, and which is conveyed toward the transfer nip passes; and a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member, wherein the controller is capable of executing a first operation in which the back surface printing is performed with a first interval from the immediately-before printing and a second operation in which the back surface printing is performed with a second interval longer than the first interval from the immediately before printing, wherein the controller is capable of executing the first operation in a case where there is no designation of the second operation by the user, and is capable of executing the second operation in a case where there is the designation, and wherein in a case where detection that there is no sheet corresponding to the objective sheet is made by the detecting portion, an amount of toner deposited on the transfer member by passing, through the transfer nip, of the toner image formed in the immediately-before printing is larger when the designation is made than when the designation is not made.

According to a further aspect of the present disclosure, there is provided an image forming apparatus comprising: an image bearing member; an intermediary transfer member onto which a toner image formed on the image bearing member is transferred; a transfer member configured to transfer the toner image, transferred on the intermediary transfer member, onto a sheet, the transfer member forming a transfer nip between the intermediary transfer member and the transfer member; an accommodating portion configured to accommodate the sheet; a detecting portion configured to detect presence or absence of the sheet in the accommodating portion; a double-sided conveying path through which the sheet which has a front surface on which an image is formed, and which is conveyed toward the transfer nip passes; and a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member, wherein the controller is capable of executing a first operation in which the toner image formed in the back surface printing is transferred onto the re-conveying sheet, a second operation in which a cleaning operation of the transfer member is performed before the toner image formed in the back surface printing reaches the transfer nip and then the toner image formed in the back surface printing is transferred onto the re-conveying sheet, and a third operation in which the cleaning operation is performed after the toner image formed in the back surface printing passes through the transfer nip and then the toner image formed by executing the back surface printing again is transferred onto the re-conveying sheet, wherein the controller is capable of executing the first operation in a case where a predetermined condition is not satisfied, and is capable of executing the second operation or the third operation depending on an interval between the immediately-before printing and the back surface printing in a case where the predetermined condition is satisfied, wherein the predetermined condition includes at least one of that an environmental temperature is a predetermined temperature or more, that a remaining lifetime of a developing device is less than a predetermined value, that a user designates the second operation, that an image density in the immediately-before printing is a predetermined value or more, that an image in the immediately-before printing includes an image other than a text image, and that a maximum density of a part of a region in the immediately-before printing is a predetermined value or more, and wherein in a case where detection that there is no sheet corresponding to the objective sheet is made by the detecting portion, the toner image formed in the immediately-before printing before the first operation, the second operation, or the third operation passes through the transfer nip.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of a laser printer engine in embodiments 1 to 5.

FIG. 2 is a hardware configuration diagram in the embodiments 1 to 5.

FIG. 3 is a functional block diagram in the embodiments 1 to 3.

FIG. 4 is a flowchart for illustrating a conventional technology for comparison with an embodiment 1.

FIG. 5 is a communication sequence diagram for illustrating the conventional technology for comparison with the embodiment 1.

FIG. 6 is a sequence diagram for illustrating the conventional technology for comparison with the embodiment 1.

FIG. 7 is a sequence diagram for illustrating the conventional technology for comparison with the embodiment 1.

FIG. 8 is a flowchart showing discharge propriety discrimination processing in the embodiment 1.

FIG. 9 is a sequence diagram in the case where the discriminate propriety discrimination processing in the embodiment 1 is carried out.

FIGS. 10A and 10B are flowcharts each showing discharge propriety discrimination processing in the embodiment 2.

FIG. 11 is a sequence diagram in the case where the discriminate propriety discrimination processing in the embodiment 2 is carried out.

FIG. 12 is a flowchart showing discharge propriety discrimination processing in the embodiment 3.

FIG. 13 is a sequence diagram in the case where the discriminate propriety discrimination processing in the embodiment 3 is carried out.

FIG. 14 is a functional block diagram in the embodiments 4 and 5.

FIG. 15A is a flowchart showing discharge propriety discrimination processing in the embodiment 4.

FIG. 15B is a flowchart showing discharge propriety discrimination processing in the embodiment 4.

FIGS. 16A, 16B, and 16C are sequence diagrams each in the case where the discriminate propriety discrimination processing in the embodiment 4 is carried out.

FIG. 17 is a flowchart showing discharge propriety discrimination processing in the embodiment 5.

### DESCRIPTION OF THE EMBODIMENTS

In the following, an image forming apparatus capable of executing double-sided printing of an image on a sheet as a recording medium will be described. In the following, the sheet is simply referred to as paper in some instances, but the paper is merely an example of the sheet, and the image can also be formed on a sheet other than the paper.

### Embodiment 1

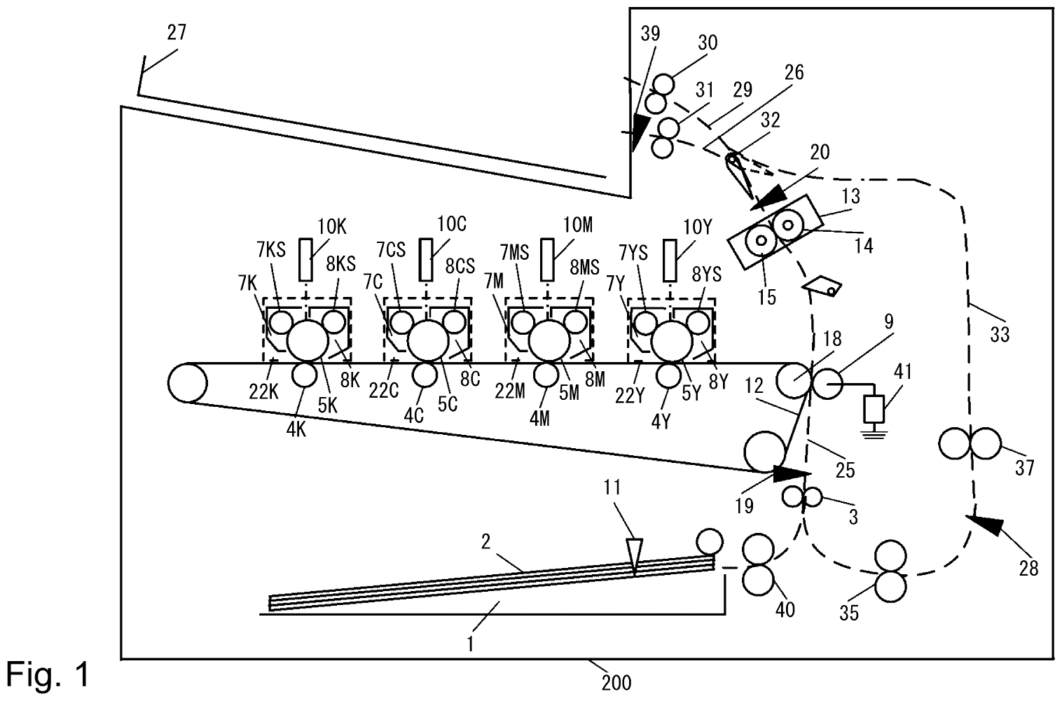

In the following, an embodiment 1 to which the present invention is applicable will be described. As the image forming apparatus, an outline of a general constitution of a laser printer engine will be described using FIG. 1.

### (Outline of Image Forming Apparatus)

A laser printer engine 200 (hereinafter, simply referred to as a printer 200) forms an electrostatic latent image by image light formed on the basis of an image signal sent from a controller (portion) (not shown), and then forms a color visible image by developing the electrostatic latent image and then by superposedly transferring resultant visible images. The (unfixed) color visible image is transferred onto a sheet 2 and then is fixed on the sheet 2. An image forming portion is constituted by photosensitive drums 5Y, 5M, 5C, and 5K, chargers (charging devices) 7Y, 7M, 7C, and 7K, developing devices 8Y, 8M, 8C, and 8K, and an intermediary transfer belt 12, which are provided for stations juxtaposed correspondingly to development colors, respectively. Incidentally, Y, M, C and K represent, yellow, magenta, cyan, and black, respectively, and hereinafter, suffixes Y, M, C, and K of reference numerals or symbols will be omitted except for the case where a member for a specific color is described.

The photosensitive drum 5 as an image bearing member, the charger 7 as a charging means, and the developing device as a developing means are mounted in a process cartridge 22 detachably mountable to a main body of the printer 200. Incidentally, the developing device 8 and a toner accommodating portion (not shown) may be constituted as a cartridge (toner cartridge, developing cartridge) detachably mountable to the main body of the printer 200. The photosensitive drum 5 is constituted by applying an organic photoconduction layer onto an outer peripheral surface of an aluminum cylinder, and is rotated by transmission thereto a driving force of a driving motor (not shown). The driving motor rotates the photosensitive drum 5 in the clockwise direction depending on an image forming operation. Exposure light to the photosensitive drum 5 is sent from a scanner portion 10, and a surface of the photosensitive drum 5 is selectively exposed to the exposure light, so that the electrostatic latent image is formed on the photosensitive drum 5. The stations are provided with the four chargers 7Y, 7M, 7C, and 7K for electrically charging the photosensitive drums 5Y, 5M, 5C, and 5K for yellow (Y), magenta (M), cyan (C), and black (K), respectively. The chargers 7Y, 7M, 7C, and 7K are provided with sleeves 7YS, 7MS, 7CS, and 7KS, respectively. In order to visualize the electrostatic latent images, the stations are provided with the four developing devices 8Y, 8M, 8C, and 8K for developing the electrostatic latent images for yellow (Y), magenta (M), cyan (C), and black (K), respectively. The developing devices 8Y, 8M, 8C, and 8K are provided with sleeves (developing rollers) 8YS, 8MS, 8CS, and 8KS, respectively. Each of the developing devices 8Y, 8M, 8C, and 8K are detachably mounted to the main body of the printer 200.

The intermediary transfer belt 12 as an intermediary transfer member contacts the photosensitive drums 5Y, 5M, 5C, and 5K and is rotated in the counterclockwise direction during color image formation. The intermediary transfer belt 12 is rotated with rotation of the photosensitive drums 5Y, 5M, 5C, and 5K, and onto which the visible images are transferred by a primary transfer voltages applied to primary transfer rollers 4Y, 4M, 4C, and 4K (hereinafter, this transfer is referred to as primary transfer). The intermediary transfer belt 12 nips and conveys the sheet 2 in a position of a secondary transfer roller 9 as a transfer member in cooperation with a secondary transfer opposite roller 18, so that the color visible images are superposedly transferred onto the sheet 2 (hereinafter, this transfer is referred to as secondary transfer). A region in which the secondary transfer roller 9 and the intermediary transfer belt 12 are in contact with each other is referred to as a secondary transfer portion (transfer nip). That is, the secondary transfer roller and the intermediary transfer belt are in contact with each other so as to form the secondary transfer portion (transfer nip).

The primary transfer rollers 4Y, 4M, 4C, and 4K are pressed toward the photosensitive drums 5Y, 5M, 5C, and 5K, respectively, through the intermediary transfer belt 12. Further, to the primary transfer rollers 4, a primary transfer power source (not shown) for applying a primary transfer voltage is connected. By the primary transfer voltage source, the primary transfer voltage of a positive polarity which is an opposite polarity to a normal charge polarity of the toner is applied to the primary transfer rollers 4Y, 4M, 4C, and 4K. By this, toner images on the photosensitive drums 5Y, 5M, 5C, and 5K are primarily transferred onto the intermediary transfer belt 12 (intermediary transfer member). The secondary transfer roller 9 has a structure and physical properties similar to those of the primary transfer rollers 4Y, 4M, 4C, and 4K. The secondary transfer roller 9 is pressed toward the intermediary transfer belt 12 through the sheet 2. Further, to the secondary transfer roller 9, a secondary transfer power source 41 as a secondary transfer voltage applying means is connected.

The secondary transfer power source 41 applies a voltage to the secondary transfer roller 9 so as to generate a potential difference between the secondary transfer roller 9 and the intermediary transfer belt 12. An engine controller 301 described later is constituted so as to control the secondary transfer power source 41 in order to execute a first applying operation and a second applying operation. Here, in the first applying operation, the toner charged to the normal polarity receives an electrostatic force in a direction from the intermediary transfer belt 12 toward the secondary transfer roller 9. On the other hand, in the second applying operation, the toner charged to the normal polarity receives the electrostatic force in a direction from the secondary transfer roller 9 toward the intermediary transfer belt 12.

That is, by the secondary transfer power source 41, to the secondary transfer roller 9, voltages of both polarities including a negative polarity which is the normal charge polarity of the toner and the positive polarity which is the opposite polarity to the normal charge polarity of the toner are capable of being applied.

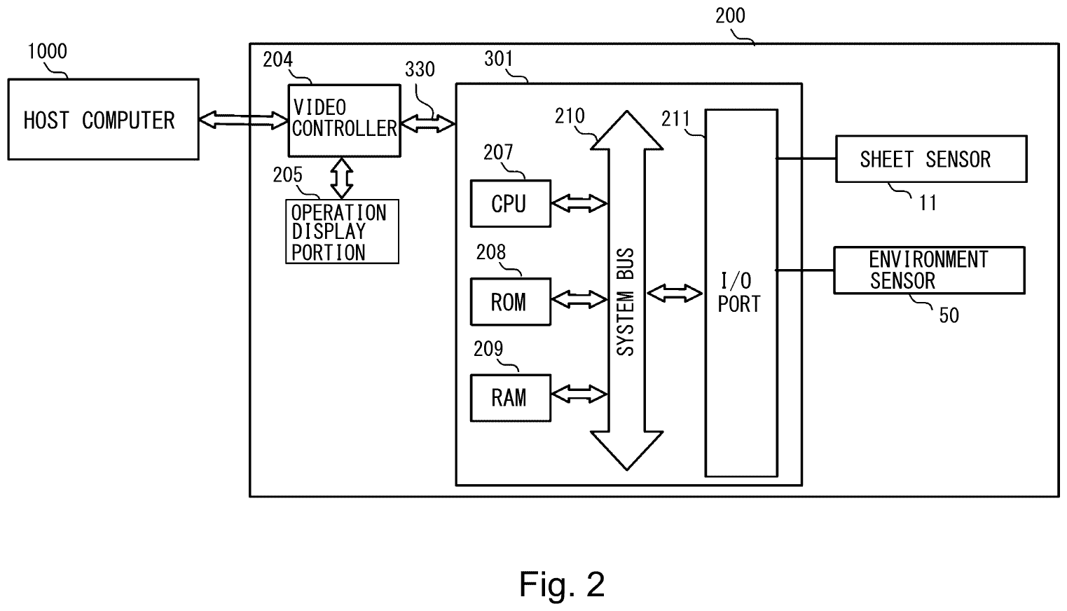

A fixing portion 13 as a fixing means fixes a transferred unfixed color visible image on the sheet 2 while conveying the sheet 2. The fixing portion 13 includes a fixing roller 14 for heating the sheet 2 and a pressing roller 15 for causing the sheet 2 to press-contact the fixing roller 14. Each of the fixing roller 14 and the processing roller 15 is formed in a hollow shape, and inside the fixing roller 14, a heater is incorporated. That is, the sheet 2 holding the color inside image is conveyed by the fixing roller 14 and the pressing roller 15, and in addition, the toner is fixed on a surface of the sheet 2 under application of heat and pressure. The sheet 2 after the fixing of the visible image is conveyed to a discharge conveyance path 26 and is discharged to a discharge portion by a discharging conveying roller 31, so that the image forming operation is ended. A full-state sensor 39 is an sensor for detecting a full state of a plurality of surfaces 2 (sheet bundle) discharged and stacked on a discharge tray 27. Incidentally, in a conveying path (conveying passage) of the sheet 2, a registration sensor 19 capable of detecting arrival of a leading end of the conveyed sheet 2 and passing of a trailing end of the conveyed sheet 2, a fixing discharge sensor 20, and a double-sided conveyance sensor 28 are provided. Further, a sheet (paper) feeding part of the cassette 1 as an accommodating portion is provided with a sheet sensor 11 as a detecting means for detecting presence or absence of the sheet 2 in the cassette 1. A conveying roller 40 and a registration roller pair 3 are rollers for conveying the sheet 2. In the printer 200, an environment sensor 50 (see FIG. 2 or the like) capable of detecting a temperature/humidity of an environment in which the printer 200 is installed.

Next, double-sided conveyance control when printing of images on a front surface (side) as a first surface (side) of the sheet 2 and a back surface (side) as a second surface (side) on a side opposite from the first surface is performed will be described. The sheet 2 subjected to printing on the front surface thereof and passing through the fixing portion 13 is conveyed toward a double-sided reversal path 29 by switching a double-sided flapper 32 by a reversing clutch (not shown). Incidentally, in FIG. 1, the double-sided flapper 32 indicated by a solid line shows a state in which the sheet 2 is conveyed toward the double-sided reversal path 29, and the double-sided flapper 32 indicated by a broken line shows a state in which the sheet 2 is conveyed toward the discharge conveyance path 26. Incidentally, the double-sided flapper 32 indicated by the broken line also has a function of preventing the sheet 2 conveyed to the double-sided reversal path 29 from moving an opposite direction toward the fixing portion 13.

When the trailing end of the sheet 2 reaches the double-sided reversal path 29, a rotational direction of a reversing roller 30 is switched by the reversing clutch (not shown), and in addition, the double-sided flapper 32 is switched, so that the sheet 2 is conveyed along a double-sided conveyance path 33 by a double-sided conveying roller pair 37 and a double-sided re-feeding roller pair 35. Thus, the sheet 2 enters the printing conveyance path 25 again in a state in which the sheet 2 is turned upside down and then, transfer and fixing of the toner image on the back surface of the sheet 2 are performed, and the sheet 2 is discharged to a discharge portion. Here, backside contamination of the sheet 2 fed from the double-sided conveyance path 33 becomes contamination on the front surface (first surface) of the sheet 2 on which the image formation is ended. Incidentally, the sheet 2 conveyed from the double-sided conveyance path 33 to the secondary transfer portion is also referred to as a re-conveying sheet. At this time, a printing (print) operation in which the toner image for being transferred onto the re-conveying sheet conveyed from the double-sided conveyance path 33 to the secondary transfer portion is referred to as back surface printing.

Further, the sheet conveyed to the secondary transfer portion immediately before the re-conveying sheet is conveyed to the secondary transfer portion is referred to as an objective sheet. A printing operation in which the toner image for being transferred onto the objective sheet is referred to as immediately-before printing.

### (Hardware Configuration)

A hardware configuration of the embodiment 1 will be described using FIG. 2. The printer 200 is constituted by an operation display portion 205, a video controller 204, and the engine controller 301 as a control means. The video controller 204 sends, to the operation display portion 205, a state of the printer 200 received from the engine controller 301. The operation display portion 205 switches information displayed on the basis of the received state of the printer 200. In the operation display portion 205, an operation panel, operation buttons (not shown), and the like are included. Further, the video controller 204 receives image information and a print instruction from a host computer 1000. The video controller 204 analyzes and converts the received image information into bit data, and then sends, through a video interface processing portion 330, a print reservation command, a print start command, and video signals to the engine controller 301 for each page.

The engine controller 301 is a control IC constituted by a CPU (central processing unit) 207, a ROM (read-only memory) 208, a RAM (random-access memory) 209, and an IO port 211. The CPU 207 loads a program and various data from the ROM 208 and executes the program by using the RAM as a working area. The above-described constituent elements is capable of accessing the IO port 211 through a system bus 210 capable of bidirectional access. To the IO port 211, actuators (not shown) are connected, so that the actuators for realizing a conveying operation of the sheet 2 (hereinafter, this operation is referred to as a sheet conveying operation), an image forming operation, an initializing operation, and the like through the IO port 211. Further, to the IO port 211, the sheet sensor 11 in the cassette 1 is connected, and detects presence or absence of the sheet 2 in the cassette 1 through the IO port 211. In addition, to the IO port 211, the environment sensor 50 is connected, and detects an ambient temperature and an ambient humidity of an environment in which the printer 200 is installed.

### (Functional Block)

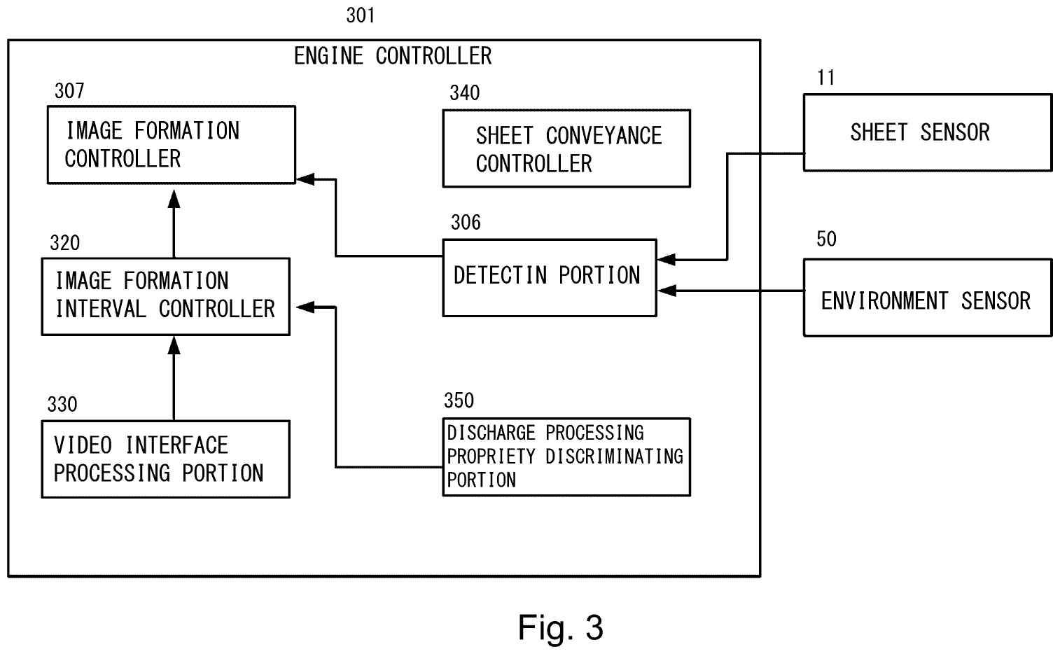

Next, a functional block of the embodiment 1 will be described using FIG. 3. Here, only a portion relating to the embodiment 1 is extracted and described. The engine controller 301 in the embodiment 1 has a function of a main controller for performing the sheet conveying operation and the image forming operation of the printer 200. An image formation controller 307 carries out control of a series of image forming processes from image formation onto the photosensitive drum 5 (image bearing member) to transfer and fixing of the image onto the sheet 2 in accordance with an image interval determined by an image formation interval controller 320. Similarly, a sheet conveyance controller 340 carries out control of the sheet conveying operation from feeding of the sheet 2 from the cassette 2 until the sheet 2 is discharged to an outside of the printer (hereinafter, this control is referred to as sheet conveyance control).

The image formation interval controller 320 determines an interval of the image formation in accordance with a content of the print reservation received from the video controller 204 and an operation status of the printer 200. The video interface processing portion 330 performs communication processing between the engine controller 301 and the video controller 204. A detecting portion 306 inputs, to the engine controller 301, signals of the sheet sensor 11 and the environment sensor 50. A discharge processing propriety discriminating portion 350 (hereinafter, simply referred to as a propriety discriminating portion 350) is a means for preliminarily discriminating execution propriety of discharge processing (discharging processing) in the secondary transfer portion in the case where there is no sheet in the cassette 1 during double-sided printing, and is also a means for performing prediction of the backside contamination. The discharge processing will be described later. A state in which there is no sheet in the cassette 1 can be called “no paper”, “no sheet”, or the like.

### (Conventional Operation Flowchart)

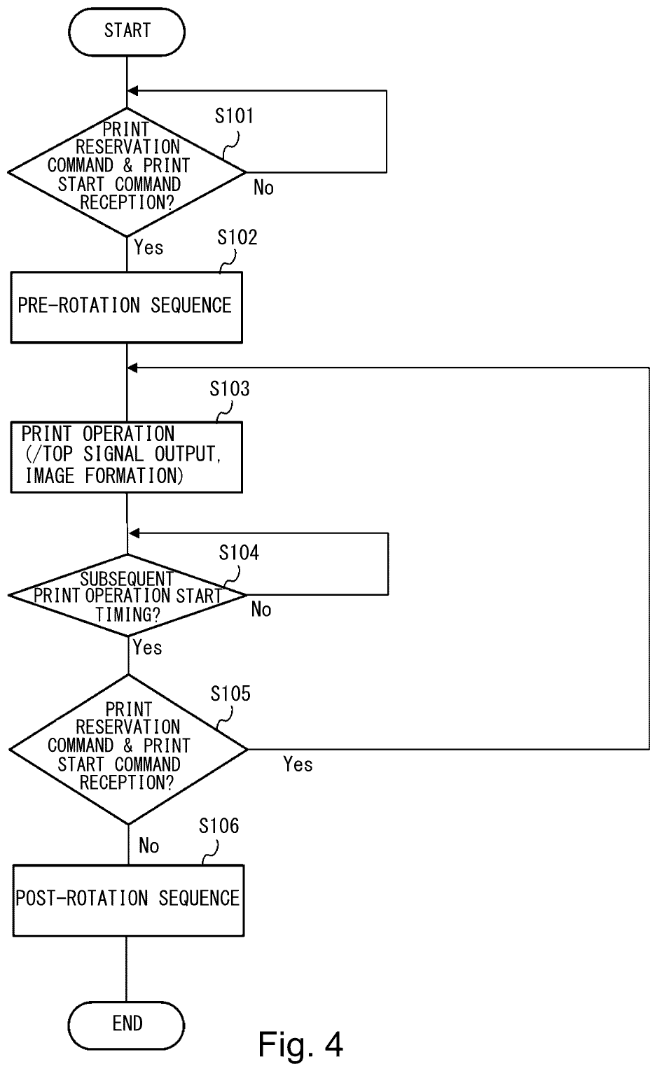

FIG. 4 is a flowchart of a printing operation performed by the engine controller 301. In a step (hereinafter, abbreviated as “S”) 101, the engine controller 301 discriminates whether or not the engine controller 301 received the print reservation command and the print start command from the video controller 204 through the video interface processing portion 330. In the case where the engine controller 301 discriminated in S101 that the engine controller 301 do not receive these commands, the engine controller 301 causes the processing to return to S101, and in the case where the engine controller 301 discriminated in S101 that the engine controller 301 received these command, the engine controller 301 causes the discharge to go to S102. In S102, the engine controller 301 executes pre-processing for performing the printing operation (hereinafter, this processing is referred to as a “pre-rotation sequence”). In S103, the engine controller 301 outputs/TOP signal to the image formation controller 307 and starts the printing operation in accordance with a print reservation command for a first sheet. Further, the engine controller 301 determines an interval of the image formation by the image formation interval controller 320. In S104, in accordance with the image formation interval determined in S103, the engine controller 301 discriminates whether or not a timing becomes a timing when a start of the printing operation for a subsequent page is enabled.

Incidentally, the engine controller 301 includes a timer (not shown) and performs management of the timing by resetting and starting the timer in S103. In S104, in the case where the engine controller 301 discriminated that the timing is not a start timing of a subsequent printing operation, the engine controller 301 causes the processing to return to S104, and in the case where the engine controller 301 discriminated that the timing is the start timing of the subsequent printing operation, the engine controller 301 causes the processing to go to S105.

In S105, the engine controller 301 discriminates whether or not the engine controller 301 receives a print reservation command and a print start command for a subsequent printing operation from the video controller 204 through the video interface processing portion 330. In the case where the engine controller discriminated in S105 that the engine controller 301 received these commands, the engine controller 301 causes the processing to return to S103, and then a printing operation for a subsequent page is started.

In the case where the engine controller 301 discriminated in S105 that the engine controller 301 do not receive the subsequent print reservation command and the print start command, and causes the processing to go to S106. In S106, the engine controller 301 executes a post-processing of the printing operation (hereinafter, this processing is referred to as a “post-rotation sequence”), and ends the printing operation.

### (Communication Sequence)

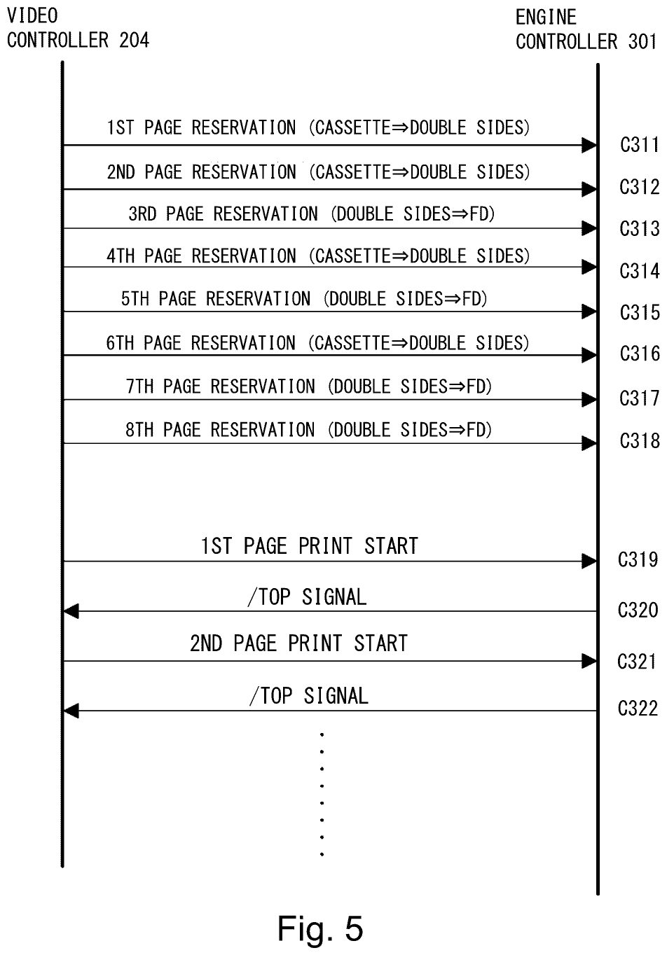

FIG. 5 is a communication sequence between the engine controller 301 and the video controller 204 until sheet feeding from the cassette 1 and sheet feeding from the double-sided conveyance path 33 are alternately performed and double-sided printing of images on four sheets is started. In C311, the video controller 204 sends, as a first page reservation, a print reservation command for feeding the sheet from the cassette 1 and discharging the sheet toward a double-sided unit (illustrated as “CASSETTE⇒DOUBLE SIDES”), to the engine controller 301. This page is a reservation for the front surface of the first sheet. In C312, the video controller 204 sends, as a second page reservation, a print reservation command for feeding the sheet from the cassette 1 and discharging the sheet toward the double-side unit, to the engine controller 301. This page is a reservation for a front surface of a second sheet. In C313, the video controller 204 sends, as a third page reservation, a print reservation command for feeding the sheet from the double-sided unit toward the discharge portion of the outside of the printer (illustrated as “DOUBLE SIDES⇒FD”), to the engine controller 301. This page is a reservation for a back surface of the first sheet. These operations are similarly performed for remaining reservation IDs (C314, C315, C316, C317, C318). By this, print reservation commands are sent from the video controller 204 to the engine controller 301 in an order of first sheet front surface⇒second sheet front surface⇒first sheet back surface⇒third sheet front surface⇒second sheet back surface⇒fourth sheet front surface ⇒third sheet back surface⇒fourth sheet back surface.

Next, in C319, the video controller 204 provides, to the engine controller 301, a print start instruction for a page reserved by a print reservation command (first page print start), so that the printer 200 starts the printing operation. In C320, the engine controller 301 starts an image forming sequence after receiving the print start command and outputs the/TOP signal, thus performing image formation. On the other hand, the video controller 204 outputs a video signal in synchronism with the/TOP signal (not shown). When the output of the video signal for the first page, in C321, the video controller 204 outputs, to the engine controller 301, a print start command for a subsequent print reservation page (second page print start). In S322, the engine controller 301 starts the image forming sequence after receiving the print start command and outputs the/TOP signal, thus performing the image formation. Thereafter, the processing is similarly performed also for remaining print reservation pages (third to eighth page reservations). Incidentally, as shown by the reservation commands C311 to C318, alternate sheet feeding from the cassette 1 and the double-sided conveyance path 33 while causing a single sheet to wait in the double-sided conveyance path 33 is hereinafter referred to as “two-sheet alternate double sides”. Incidentally, alternate double-sided printing is not limited to the two-sheet alternate double sides, but may also be another alternate double-sided printing such as three-sheet alternate double-sides, or the like.

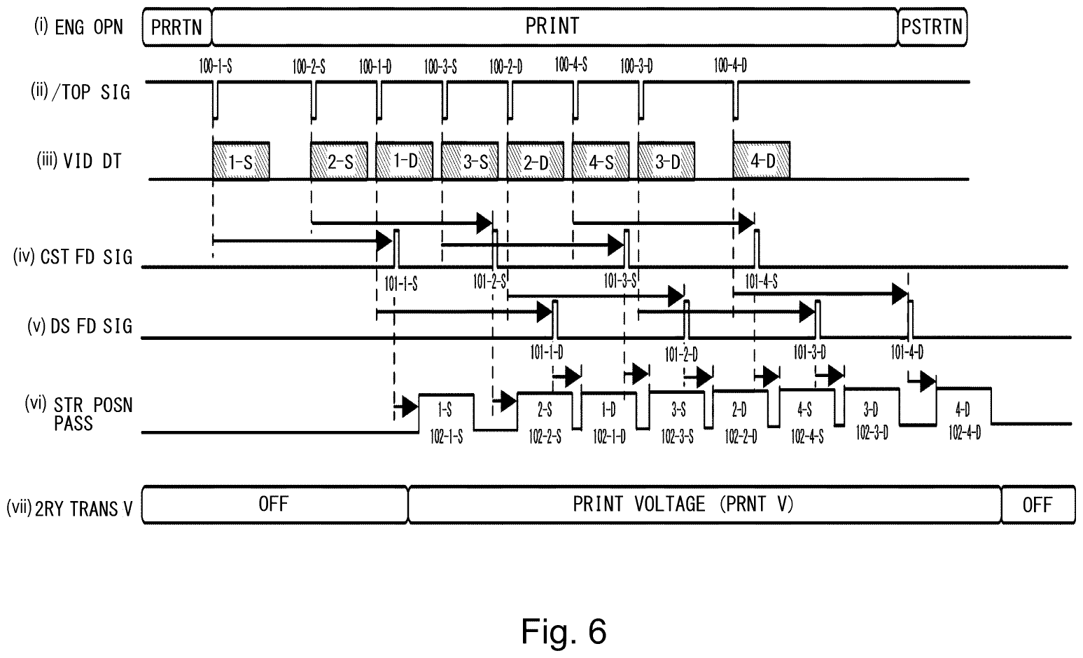

FIG. 6 shows an image forming sequence in the case where the image formation is carried out in accordance with a communication sequence of the two-sheet alternate double-sided printing described with reference to FIG. 5. In FIG. 6, (i) operation of printer 200 (engine operation), (ii)/TOP signal, and (iii) video data are shown. In addition, (iv) sheet feeding signal when sheet is fed from cassette 1 (cassette sheet feeding signal), (v) sheet feeding signal when sheet is fed from double-sided conveyance path 33 (double-side sheet feeding signal), (vi) secondary transfer roller position passing, nd (vii) secondary transfer voltage are shown. Incidentally, in the following, in a double-sided printing, a surface on which an image is first printed on a single sheet 2 fed from the cassette 1 and discharged to the double-sided unit is referred to as a front surface, and a surface fed from the double-sided unit and discharged to the outside of the printer 200 is referred to as a back surface.

### (Paper (Sheet) Presence)

The engine controller 301 starts a pre-rotation sequence when a print start command (print ID=1) for a first sheet front surface print reservation command (first page reservation) is received as described above. After the pre-rotation sequence is ended, the engine controller 301 starts a printing operation for the first sheet is started by outputting the/TOP signal (100-1-S). The engine controller 301 forms the toner image on the intermediary transfer belt 12 in accordance with a video data 1-S sent from the video controller 204. After a lapse of a predetermined time from the output of the/TOP signal, the engine controller 301 starts sheet feeding from the cassette 1 by outputting a sheet feeding signal in synchronism with a timing when the toner image formed on the intermediary transfer belt 12 reaches the secondary transfer roller position (101-1-S). When a leading end of the sheet 2 fed from the cassette 1 is detected by the registration sensor 19, the engine controller 301 increases or decreases a sheet feeding speed so that a leading end of the toner image formed on the intermediary transfer belt 12 and the leading end of the sheet 2 coincide with each other. After a lapse of a predetermined time from the sheet feeding instruction, the toner image formed on the intermediary transfer belt 12 and the fed sheet 2 pass through the secondary transfer portion (102-1-S), so that a toner image 1-S is transferred from the intermediary transfer belt 12 onto the sheet 2. At this time, in synchronism with a timing when the sheet 2 passes through the secondary transfer portion, a first voltage for printing (hereinafter, this voltage is also referred to as a print voltage) is applied to the secondary transfer roller 9 by a secondary transfer power source 41. By this, the toner image on the intermediary transfer belt 12 is secondarily transferred onto the sheet 2. The toner image transferred on the sheet 2 is heated and fixed by the fixing portion 13, so that formation of the image on the front surface of the first sheet is ended. The sheet 2 on which the image formation on the front surface of the first sheet is carried out is conveyed toward the double-side unit (double-sided conveyance path 33).

Similarly, when the engine controller 301 receives a print start command (print ID=2) for a second sheet front surface print reservation command (second page reservation), the engine controller 301 outputs a/TOP signal (100-2-S) and starts a printing operation for the second sheet front surface. The engine controller 301 forms a toner image in accordance with a video data 2-S. After a lapse of a predetermined time from the output of the/TOP signal, the engine controller 301 starts sheet feeding by feeding the sheet 2 from the cassette 1 (101-2-S). After a lapse of a predetermined time from the sheet feeding instruction, the toner image formed on the intermediary transfer belt 12 and the fed sheet 2 pass through the secondary transfer portion, so that transfer of a toner image 2-S is performed (102-2-S). Then, after heat-fixing of the toner image 2-S by the fixing portion 13 is performed, the sheet 2 is conveyed toward the double-sided unit.

Next, when the engine controller 301 receives a print start command (print ID=2) for a first sheet back surface print reservation command (third page reservation), the engine controller 301 outputs a/TOP signal (100-1-D) and starts a printing operation for the first sheet back surface. After a lapse of a predetermined time from the output of the/TOP signal, the engine controller 301 starts sheet feeding by outputting a sheet feeding signal (101-1-D). After a lapse of a predetermined time from the sheet feeding instruction, the toner image formed on the intermediary transfer belt 12 and the fed sheet 2 pass through the secondary transfer portion, so that transfer of a toner image 1-D onto the sheet 2 is performed (102-1-D), so that heat-fixing of the toner image 1-D is performed. The sheet 2 (first sheet) on which the toner images are formed on the front surface and the back-surface are discharged to the outside of the printer 200.

The engine controller 301 repeats the above-described operations for four sheets and executes a post-rotation sequence at a time when formation of all the images is ended, and after a final sheet 2 (fourth sheet) passes through the secondary transfer portion, the output of the voltage applied to the secondary transfer roller 9 is stopped. By the above processing, the series of printing operations is ended.

### (Paper (Sheet) Absence)

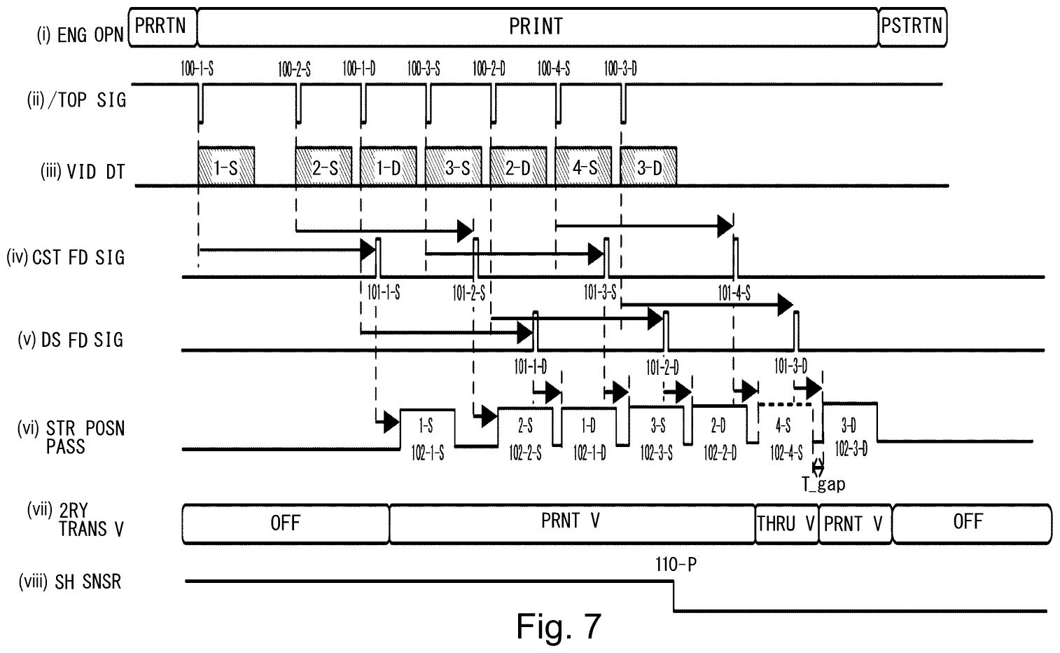

FIG. 7 is an image forming sequence in the case where there is no sheet in the cassette 1 for the fourth sheet during execution of the image forming sequence described with reference to FIG. 6 in accordance with the communication sequence of the two-sheet alternate double sides described with reference to FIG. 5, and thus the printing cannot be continued. In FIG. 7, (i) to (vii) are similar to those in FIG. 6. In FIG. 7, (viii) shows a detection result of the sheet sensor 11. Further, description of reference numerals or symbols in FIG. 7 is similar to that with reference to FIG. 6. The fourth sheet for which the sheet absence occurs in a sheet corresponding to the above-described objective sheet.

As shown in FIG. 7, the engine controller 301 causes the sheet sensor 11, for detecting presence/absence of the sheet 2 in the cassette 1, to detect the absence of the fourth sheet in the cassette 1 at a timing 110-P. At the timing 110-P, a/TOP signal (100-4-S) for a fourth-sheet front surface has already been outputted and image formation on a third sheet back surface is ended, and than a/TOP signal (100-3-D) for a third-sheet back surface is outputted, so that image formation on the third sheet back surface is started. Here, a toner image 4-S is a toner image formed by immediately-before printing, and a toner image 3-D is a toner image formed by back surface printing. That is, after the immediately-before printing and the back surface printing are started, the presence/absence of the sheet in the cassette 1 is detected by the sheet sensor 11.

### (Through Voltage)

Here, the sheet absence occurs, and therefore, the fourth sheet 2 is not conveyed to the secondary transfer portion. For that reason, there is a need that the fourth-sheet front surface toner image (4-S indicated by a broken line in (vi) of FIG. 7) formed on the intermediary transfer belt 12 is passed through the secondary transfer portion and that the third-sheet back surface toner image 3-D formed thereafter onto the sheet 2 conveyed from the double-side unit. Incidentally, the term “passed through” is processing in which the toner image is passed through the secondary transfer portion while being kept in a state in which the toner image is carried on the intermediary transfer belt 12 without being secondarily transferred (hereinafter, this processing is referred to as through processing). The engine controller 301 executes the through processing in response to detection of the sheet absence by the sheet sensor 11.

When the toner is deposited on the secondary transfer roller 9 when the fourth-sheet front surface toner image is passed through the secondary transfer portion, in the secondary transfer step of the toner image on the subsequent third-sheet back surface, the toner deposited on the secondary transfer roller 9 is deposited on the sheet 2, so that backside contamination of the sheet 2 with the toner occurs. Ordinarily, in the case where the toner image which is not transferred onto the sheet 2 is passed through the secondary transfer portion, a polarity of a voltage applied to the secondary transfer roller 9 by the secondary transfer power source 41 is changed. Specifically, the engine controller 301 causes the secondary transfer power source 41 to apply, to the secondary transfer roller 9, a second voltage (hereinafter, also referred to as a through voltage) opposite in polarity to the first voltage (print voltage) when the toner image is transferred onto the sheet 2. That is, the toner is sucked toward the intermediary transfer belt 12 side by an electrostatic force, so that the above-described second applying operation is performed so that the toner image 4-S formed in the immediately-before printing is not deposited onto the secondary transfer roller 9.

However, of toner particles, those deviated from a normal electrostatic characteristic (hereinafter, these toner particles are also called reversely charged toner) slightly present in a certain proportion. Such toner particles are sucked toward the secondary transfer roller 9 side even in a situation in which the through voltage is applied to the secondary transfer roller 9, and thus are deposited on the secondary transfer roller 9. The reversely charged toner can also be said as toner deposited on the secondary transfer roller 9 by passing of the toner image through the secondary transfer portion. Such the reversely charged toner is capable of causing the backside contamination of the subsequent sheet 2, but is suppressed to a slight amount by optimization of the through voltage, so that a level at which are user is ordinarily unaware of the backside contamination (hereinafter, this level is referred to as an allowable level) is realized.

Thus, even when the sheet absence occurs in the cassette 1 during execution of the double-sided printing, the image can be normally printed on the back surface of the sheet 2 without wasting the sheet 2 which has already been subjected to one-sided printing, and the sheet 2 can be discharged to the outside of the printer.

### (Discharge Processing)

Here, due to an environment in which the printer 200 is installed and a factor such as a degree of consumption of the cartridge, a proportion of the reversely charged toner in the cartridge increases in some instances. That is, a predetermined condition is satisfied, so that the proportion of the reversely charged toner increases in some instance in an amount more than in the where the predetermined condition is not satisfied. In such a case, even when the through voltage is applied to the secondary transfer roller 9 by the secondary transfer power source 41, the amount of the reversely charged toner deposited on the secondary transfer roller 9 becomes larger than an estimated amount in some instances. In the case where it is assumed that the amount of the reversely charged toner becomes larger than the estimated amount and in the case where there is designation of the user requiring further reduction in level of the backside contamination, as processing for preventing the backside contamination of subsequent paper (sheet) with reliability, discharge processing is performed as a cleaning operation of the secondary transfer roller 9 in some instances. In general, as the discharge processing of the secondary transfer roller 9, the following processing executed after application of the through voltage to the secondary transfer roller 9 is known. That is, the processing is processing such that the secondary transfer roller 9 is rotated by not more than a distance corresponding to a peripheral length of the secondary transfer roller 9 in a state in which a third voltage (hereinafter, referred to as a discharge voltage) of the same polarity as the polarity of the first voltage (print voltage) when an ordinary toner image is transferred onto the sheet 2 (hereinafter, this processing is referred to as the discharge processing). In the discharge processing, the above-described first applying operation is executed. By this, the reversely charged toner deposited on the secondary transfer roller 9 is moved to the intermediary transfer belt 12.

However, in the case where the printing operation is performed with a highest throughput, or in the like case, as shown in FIG. 7, when the sheet absence occurs in a situation in which a/TOP signal (100-3-D) for a subsequent third-sheet back surface has already been outputted and the image formation is started, the following problem arises. That is, in an interval T_gap between a trailing end of a toner image on the fourth-sheet from surface and a leading end of a toner image on the third-sheet back surface with respect to a sheet conveying direction, there is a case where an interval in which the discharge processing is performed is not ensured. Incidentally, the interval T_gap (first interval) is such that a distance L_gap in the sheet conveying direction between a trailing end of a preceding toner image and a leading end of a subsequent toner image is expressed by a time depending on a conveying speed.

In the present disclosure, during execution of the double-sided printing, in a situation in which there is a possibility that the backside contamination cannot be suppressed to the allowable level or less even when the through voltage is applied to the secondary transfer roller 9 in the case where the sheet absence occurs, an image formation start timing is adjusted. In the present disclosure, by adjusting the image formation start timing, it is possible to ensure an interval in which the discharge processing is performed. In the following, a method in which the backside contamination is prevented by ensuring an interval in which the discharge processing of the secondary transfer roller 9 is capable of being performed will be described.

### (Discharge Propriety Discrimination Processing)

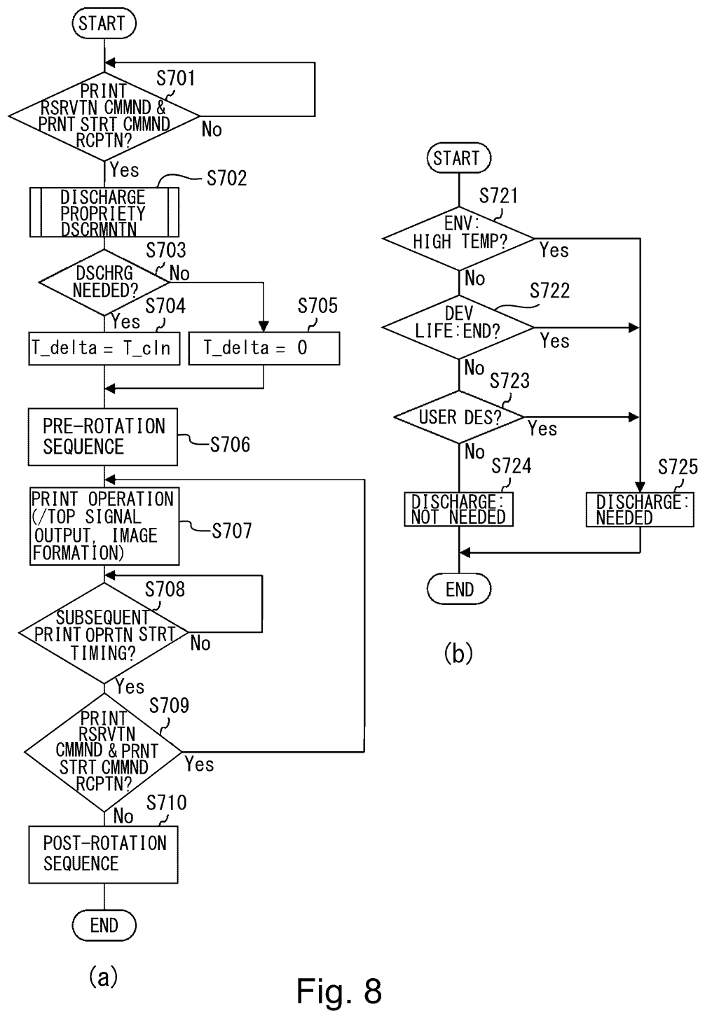

Part (a) of FIG. 8 is a flowchart of a printing operation of the engine controller 301 in the present disclosure. Incidentally, processes S701 and S706 to S710 in part (a) of FIG. 8 are similar to S101 to S106, respectively, described with reference to FIG. 4, and therefore, will be omitted from description. Incidentally, the engine controller 301 monitors a detection result of the sheet sensor 11 in a loop from S707 to S709 of part (a) of FIG. 8.

In S701, when the engine controller 301 receives a print reservation command and a print start command, the engine controller 301 performs, in S702, discharge propriety discrimination described later. The discharge propriety discrimination is processing in which in the case where the sheet absence occurs, whether or not the discharge processing of the secondary transfer roller 9 is needed is discriminated. In S703, the engine controller 301 discriminates whether or not the discharge processing is needed, on the basis of the propriety discrimination of S702. In the case where the engine controller 301 discriminated in S703 that the discharge processing is needed during the sheet absence, the engine controller 301 causes the processing to go to S704.

In S704, the engine controller 301 adjusts an image interval so that an interval such that the discharge processing of the secondary transfer roller 9 can be performed even if the sheet absence occurs when an image formation interval during subsequent printing is determined. That is, when the engine controller 301 calculates the subsequent image formation interval, as a time T_data added to a normal image formation interval described later (hereinafter, this time is referred to as an added time), the engine controller 301 sets a time T_cln required for the discharge processing of the secondary transfer roller 9 (hereinafter, this time is referred to as a discharge time). Specifically, the engine controller 301 sets T_delta=T_cln. Here, in the embodiment 1, the discharge time T_cln is set as a time in which the secondary transfer roller 9 is capable of being rotated in not more than a distance corresponding to the peripheral length of the secondary transfer roller 9 in a state in which the discharge voltage is applied to the secondary transfer roller 9, but is not limited to this example.

In the case where the engine controller 301 discriminated in S703 that the discharge processing is not needed during the sheet absence, the engine controller 301 causes the processing to go to S705. In S705, the image formation interval during the subsequent printing may be the normal image formation interval, so that the engine controller 301 sets the add time T_depth to 0 for the normal image formation interval (T_delta=0). Here, the normal image formation interval refers to an image formation interval for realizing print productivity determined in advance as a product specification of the printer 200, and when the printer 200 is a product for performing printing of images on 60 sheets per minute, for example, the normal image formation interval is 1 second.

Incidentally, a timing when a start of a subsequent image forming operation is enabled in S708 is a timing of a lapse of a predetermined time T_next from the output of the/TOP signal in S707. The image formation interval controller 320 determines the predetermined time T_next as the following formula (1) or the following formula (2) by using the normal image formation interval represented by T_intvl and the add time T_delta set in S704 and S705.

Incidentally, in the following formulas (1) and (2), respective amounts are represented by the time, but may also be represented by a distance based on the time and the conveying speed.
Case where subsequent page is front surface:

$$T\_next = T\_intv1 \qquad formula ( 1 )$$

Case where subsequent page is back surface:

$$T\_next = T\_intv1 + T\_delta \qquad formula ( 2 )$$

As described above, the discharge processing in the embodiment 1 is for ensuring the interval in which the discharge processing of the secondary transfer roller 9 is capable of being performed between the toner image on the front surface and the toner image on the back surface. For this reason, in the case where the next (subsequent) page is the front surface, as shown in the formula (1), the/TOP signal may only be required to be always outputted in the normal image formation interval. On the other hand, in the case where the next printing operation is printing of the image on the back surface, as shown in the formula (2), the image formation interval is determined by adding the add time T_delta to the normal image formation interval T_intvl.

As regards the back surface, further in the case where the level of the backside contamination is predicted in advance is the allowable level or less, the add time T_delta is 0 (S705), and therefore, the predetermined time becomes T_next (=T_intvl). On the other hand, as regards the back surface, in the case where the level of the backside contamination is predicted as exceeding the allowable level in advance, the add time T_delta becomes the discharge time T_cln (S704), and therefore, the predetermined time becomes T_next (=T_intvl+T_cln) including this discharge time T_cln. By this, in the case where the level of the backside contamination exceeds the allowable level (the predetermined condition is satisfied) in advance, when the engine controller 301 causes the sheet sensor 11 to detect the sheet absence in the loop from S707 to S709, the discharge processing can be performed after the through processing. Further, in the case where the backside contamination is predicted in advance that the level thereof is the allowable level or less, the time of the discharge processing is not required to be ensured, and therefore, the double-sided printing can be performed.

Incidentally, due to constrains on a conveying path constitution of the product, a lowering in productivity during the double-sided printing than during the one-sided printing is determined in advance by a production specification. In such a production, in the above-described formulas (1) and (2), instead of the normal image formation interval T_intvl in the one-sided printing, a longer image formation interval T_intvl′ (>T_intvl) may only be required to be used.

Part (b) of FIG. 8 is a flowchart of the discharge propriety discrimination described in S702 of part (a) of FIG. 8, and the discharge propriety discrimination is performed by the propriety discriminating portion 350. In S721 and S722, the propriety discriminating portion 350 estimates the amount of the toner deposited on the surface of the secondary transfer roller 9 after the toner image on the front surface page passes through the secondary transfer portion under application of the through voltage. In S721, the propriety discriminating portion 350 discriminates an installation environment of the printer 200. Specifically, the propriety discriminating portion 350 discriminates whether or not the installation environment is a high temperature on the basis of a detection result of the environment sensor 50.

In general, in the case where the installation environment is a high-temperature environment, it is known that the proportion of the reversely charged toner in the toner stored in the toner container increases, so that the amount of the reversely charged toner transferred onto the surface of the secondary transfer roller 9 becomes large during application of the through voltage. For that reason, the discrimination of S721 is made on the basis of the installation environment temperature detected by the environment sensor 50. In the case where the propriety discriminating portion 350 discriminated in S721 that the installation environment of the printer 200 is the high-temperature environment on the basis of the detection result of the environment sensor 50, the propriety discriminating portion 350 causes the processing to go to S725. This is the case where the amount of the toner deposited on the surface of the secondary transfer roller 9 after the through voltage is applied to the secondary transfer roller 9 is estimated as being large. On the other hand, the propriety discriminating portion 350 discriminated in S721 that the installation environment of the printer 200 is not the high-temperature environment on the basis of the detection result of the environment sensor 50, the propriety discriminating portion 350 causes the processing to go to S722.

In S725, the propriety discriminating portion 350 causes, for example, the RAM 209 to store that the discharge processing is needed during the sheet absence, and ends the processing. Incidentally, as regards a temperature discriminated as being the high-temperature environment, in other words, as regards a threshold temperature used when the discrimination of S721 is made, such a temperature is empirically determined in advance from a correlation between the installation environment temperature and the proportion of the reversely charged toner in the cartridge. In the embodiment 1, an ambient temperature of 28° C. or more is discriminated as the high-temperature environment. That is, the threshold temperature is determined as 28° C., and the propriety discriminating portion 350 discriminates that the temperature is a “high temperature” in the case where the temperature detected by the environment sensor 50 is the threshold temperature (28° C.) or more. On the other hand, when the temperature is less than the threshold temperature (28° C.), the propriety discriminating portion 350 discriminates that the temperature is not the high temperature.

In S722, the propriety discriminating portion 350 discriminates whether or not a life time of the developing device 8 mounted in the printer 200 reaches an end, on the basis of remaining life time information of the developing device 8. In the case where the propriety discriminating portion 350 discriminated in S722 that the life time of the developing device 8 is close to the end thereof or that the developing device 8 exceeds the life time thereof, the propriety discriminating portion 350 causes the processing to go to S725. This is the case where the amount of the toner deposited on the secondary transfer roller 9 surface after the through voltage is applied to the secondary transfer roller 9 is predicted as being large. On the other hand, in the case where the propriety discriminating portion 350 discriminated in S722 that the life time of the developing device 8 reaches the end thereof, the propriety discriminating portion 350 causes the processing to go to S723.

In the case where the life time of the developing device 8 reaches the end thereof or in the case where the developing device 8 exceeds the life time thereof, it is known that the proportion of the reversely charged toner in the toner stored in the toner container increases, so that the amount of the reversely charged toner transferred onto the secondary transfer roller 9 surface during application of the through voltage to the secondary transfer roller 9 becomes large. For this reason, in the case where the life time of the developing device 8 reaches the end thereof, the propriety discriminating portion 350 causes, for example, the RAM 209 to store that the discharge processing is needed during the sheet absence in S725. Incidentally, the remaining life time of the developing device 8 is an index calculated by the engine controller 301 from a cumulative use amount or the like of the consumable part in the toner cartridge. The remaining life time of the developing device 8 is information such that the remaining life time is 100% at the time of a new article and is 0% when the remaining life time reaches an exchange timing. As regards the discrimination of the end of the life time of the developing device 8, the end of the life time is empirically determined in advance from a correlation between the remaining life time information of the developing device 8 and the proportion of the reversely charged toner in the toner cartridge. In the embodiment 1, the case where the remaining life time of the developing device 8 is less than 3% is discriminated as the end of the life time. That is, a threshold of the remaining life time threshold is determined as 3%, and the propriety discriminating portion 350 discriminates that the life time of the developing device 8 reaches the “end of life time” in the case where the remaining life time of the developing device 8 is less than the threshold (3%). On the other hand, the propriety discriminating portion 350 discriminates that the remaining life time does not reach the end thereof (end of life time) when the remaining life time is the threshold (3%) or more.

Here, the case where discrimination of “No” is made in S721 and discrimination of “No” is made in S722 is the case where the amount of the toner deposited on the surface of the secondary transfer roller 9 after the through voltage is applied to the secondary transfer roller 9 is predicted as being not large. However, there is a case where depending on a user, further reduction in level of the backside contamination is required. For this reason, discrimination of S723 is provided. In S723, the propriety discriminating portion 350 discriminates whether or not there is user designation (backside contamination prevention user designation) requiring further reduction in level of the backside contamination. In the case where the propriety discriminating portion 350 discriminated in S723 that there is the backside contamination prevention user designation, the propriety discriminating portion 350 causes the processing to go to S725, and in S725, the propriety discriminating portion 350 causes, for example, the RAM 209 to store that the discharge processing is needed during the sheet absence. Incidentally, the backside contamination prevention user designation is notified from a print setting driver or the like in the host computer 1000 to the engine controller 301 through the video interface processing portion 330.

In S724, the amount of the toner deposited on the secondary transfer roller 9 surface after the through voltage is applied to the secondary transfer roller 9 is predicted as being not large, and there is no backside contamination prevention user designation, and therefore, the propriety discriminating portion 350 causes, for example, the RAM 209 to store that the discharge processing is not needed during the sheet absence, and ends the processing.

### (Sequence Using Propriety Discrimination of Discharge Processing in Embodiment 1)

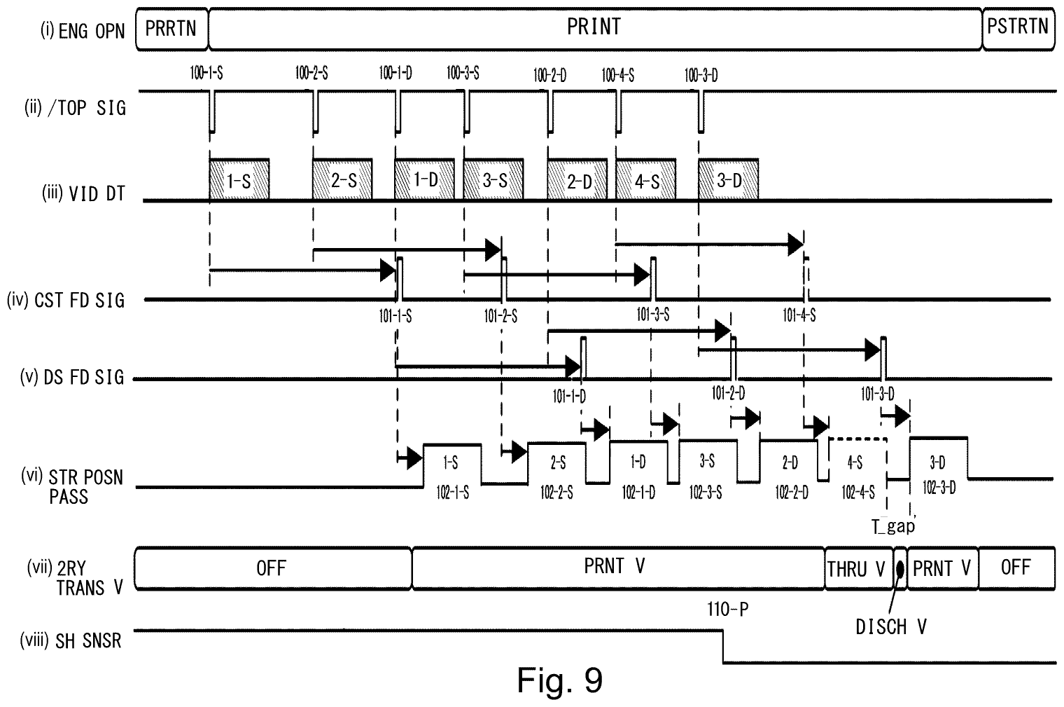

FIG. 9 is an image forming sequence in the case where sheets 2 in the cassette 1 become absent at the fourth sheet similarly as in FIG. 7, to which processing of the case where discrimination that the discharge processing is needed is made as a result of the discharge propriety discrimination described with reference to FIG. 8 is applied. That is, FIG. 9 shows the case where the predetermined time T_next when the next page is the front surface is determined by the above-described formula (1) and the predetermined time T_next when the next page is the back surface is determined by the above-described formula (2) in which the add time T_delta is changed to the discharge time T_cln. Incidentally, (i) to (vii) in FIG. 9 are similar to those in FIG. 7.

As shown in FIG. 9, an interval T_gap′ (second interval) longer than the normal interval T_gap (first interval) is ensured between from passing, through the secondary transfer portion, of the trailing end of the front surface toner image 4-S on the fourth sheet causing the sheet absence (102-4-S) to arrival of the leading end of the back surface toner image 3-D on the third sheet (102-3-D). This interval T_gap′ (second interval) is longer than the normal interval T_gap (first interval) by a distance corresponding to the discharge time T_cln of the secondary transfer roller 9. For that reason, after the through voltage is applied to the secondary transfer roller 9, the secondary transfer roller 9 is rotated by not less than an angle corresponding to a peripheral length of the secondary transfer roller 9 in a state in which the discharge voltage is applied to the secondary transfer roller 9, so that it becomes possible to perform the discharge processing. For this reason, the angle by which the secondary transfer roller 9 is rotated during passing of a portion corresponding to the second interval through the secondary transfer portion can be said as being 360° or more. Further, the angle by which the secondary transfer roller 9 is rotated during passing of a portion corresponding to the first interval through the secondary transfer portion can be said as being less than 360°.

Incidentally, an operation in which the back surface printing is executed with the interval T_gap which is the first interval from the immediately-before printing is referred to as a first operation, and an operation in which the back surface printing is executed with the interval T_gap′ which is the second interval, longer than the first interval, from the immediately-before printing is referred to as a second operation. The engine controller 301 is constituted so that the first operation is executable in the case where the predetermined condition is not satisfied and so that the second operation is executable in the case where the predetermined condition is satisfied. Further, in the case where the second operation is executed, the engine controller 301 is capable of executing the discharge processing (cleaning operation) of the secondary transfer roller 9 before the toner image formed in the back surface printing reaches the secondary transfer portion.

After the discharge processing, the toner image 3-D formed by the second operation is transferred onto the back surface of the third sheet 2 which is a re-conveying sheet.

By the above-described, according to the embodiment 1, the following control is carried out in a situation such that there is a possibility that the level of the backside contamination cannot be suppressed to the allowable level or less even when the through voltage is applied to the secondary transfer roller 9 in the case where the sheet absence occurs during execution of the double-sided printing. That is, control is carried out so that an interval in which the discharge processing of the secondary transfer roller 9 can be performed is ensured by adjusting an image formation start timing. For this reason, it becomes possible to prevent the backside contamination. In addition, the image formation start timing is adjusted only in the situation that there is the possibility that the level of the backside contamination cannot be suppressed to the allowable level or less, and therefore, ordinarily, productively is not unnecessarily lowered.

Incidentally, in the constitution in the embodiment 1, in the cassette 1, the sheet sensor 11 for detecting the presence/absence of the sheet 2 is provided, and detects the presence/absence of the sheet 2. When the image forming apparatus is an apparatus provided with a constitution in which a remaining amount of the sheets 2 in the cassette 1 is stepwise known separately from the presence/absence of the sheet 2 in the cassette 1, for example, in a situation in which the remaining amount of the sheet 2 in the cassette becomes small, it is possible to perform the above-described propriety discrimination. For example, the discharge propriety discrimination may also be performed in the case where the remaining amount of the sheet 2 becomes less than 10% of a fed sheet stacking capacity or in the like case. Specifically, in the case of the cassette 1 of which fed sheet stacking capacity is 500 sheets, the discharge propriety discrimination may only be required to be performed when the remaining amount of the sheet 2 becomes less than 50 sheets. By this, in the case where the remaining amount of the sheet 2 is 10% or more (50 sheets or more), even when the next page is the back surface, the predetermined time is determined as the predetermined time T_next of the formula (1), so that it is possible to reduce a degree of the lowering in productivity. That is, the case where the productivity lowers can be further restricted. The constitution in which the discharge propriety discrimination is made in the situation such that the remaining amount of the sheet 2 becomes small is also applicable to embodiments described later.

In the embodiment 1, as described with reference to FIG. 7, at a timing 110-P when the absence of the fourth sheet is detected by the sheet sensor 11, a/TOP signal (100-4-s) for the fourth-sheet front surface has already been outputted, and formation of the image on the fourth-sheet front surface is ended. Then, a/TOP signal (100-3-D) for a subsequent third-sheet back surface is outputted, and formation of the image on the third-sheet front surface is also started. In the embodiment 1, such a case was described. However, there is also a case where the/TOP signal (100-4-S) for the fourth-sheet front surface is not outputted, at the timing 110-P of detection of the sheet absence, depending on arrangement and dimension of constituent parts of the image forming apparatus, and a sheet size. In such a case, by using a discrimination result of the propriety discriminating portion 350 described in the embodiment 1, when the sheet absence occurs, it is also possible to adjust an output timing of the/TOP signal (100-4-S) for the fourth-sheet front surface and later. Thus, by adjusting the output timing, it is also possible to operate the image forming apparatus so that an interval in which the discharge processing of the secondary transfer roller 9 can be performed after the through voltage is applied to the secondary transfer roller 9 is ensured.

As described above, according to the embodiment 1, it is possible to suppress the lowering in productivity during the double-sided printing.

### Embodiment 2

In the embodiment 1, at the time of the start of the printing, the discharge propriety discrimination was made using the installation environment of the printer 200, the remaining life time status of the developing device 8, and the like. As a result of the discharge photosensitive drum discrimination, in the case where discrimination that the discharge processing is needed is made, the result is applied to entirety of the print job, so that during execution of the job, an interval of the/TOP signal from the front surface to the back surface was always long (see (i) T_gap′ of FIG. 9).

In the embodiment 2, the discharge propriety discrimination is performed for each page. Specifically, the discharge propriety discrimination is performed by using image information of an associated page in addition to the installation environment of the printer 200 and the remaining life time situation of the developing device 8 which are described in the embodiment 1. As a result, in the case where the sheet absence occurs during execution of the double-sided printing, the image formation start timing is adjusted only in a situation in which there is a possibility that the level of the backside contamination cannot be suppressed to the allowable level or less even when the through voltage is applied.

### (Discharge Propriety Discrimination Processing in Embodiment 2)

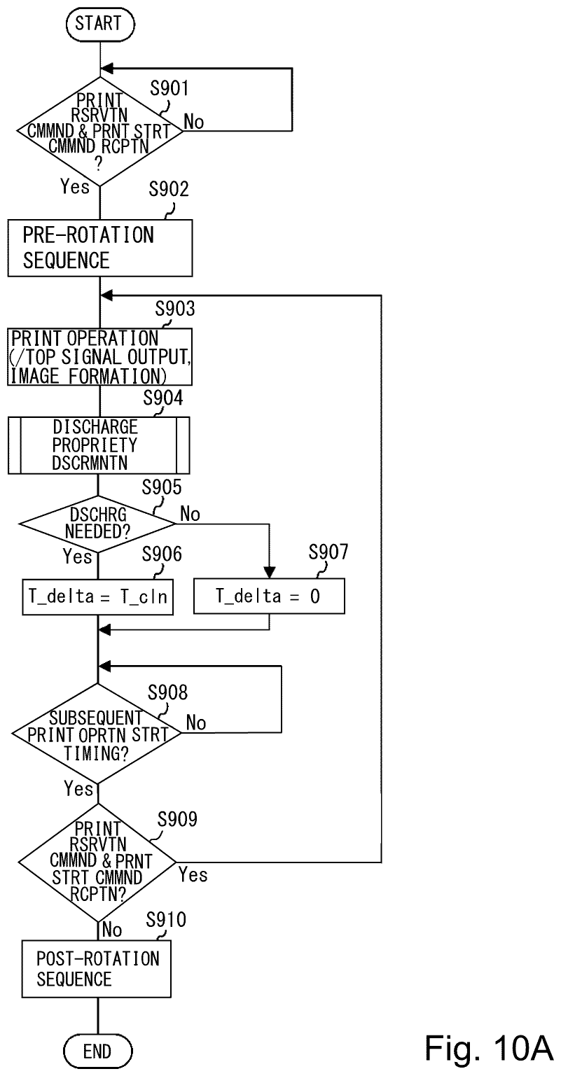

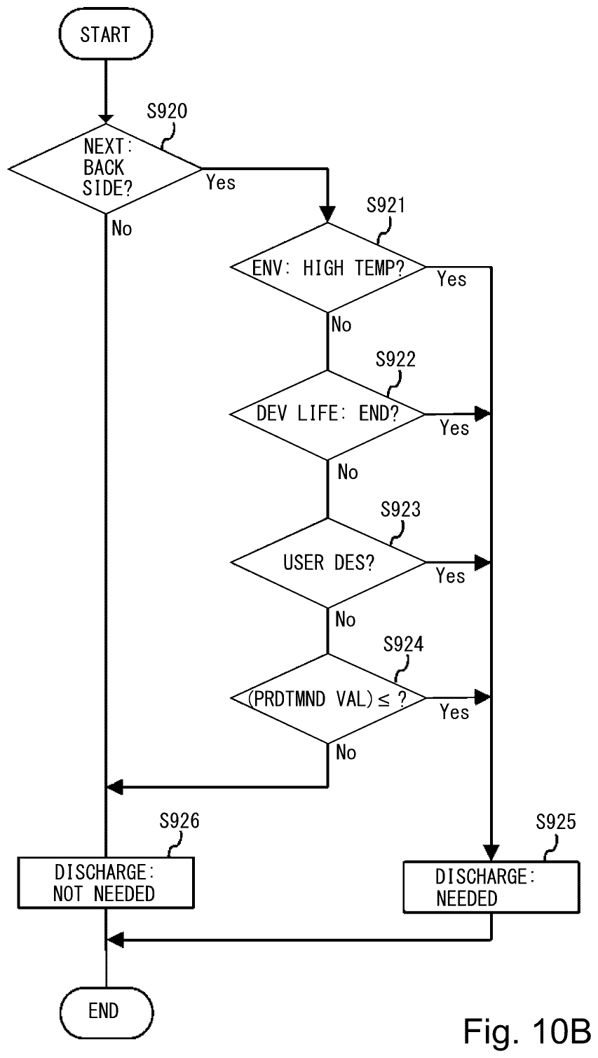

FIG. 10A is flowchart of a printing operation of the engine controller 301 in the embodiment 2. Processes S901, S902, S903, and S908 to S910 of FIG. 10A are similar to the processes S701, S706, S707, and S708 to S710, respectively, of part (a) of FIG. 8, and will be omitted from description. In part (a) of FIG. 8 in the embodiment 1, after the print reservation command and the print start command in S701 are received (Yes of S701) and before the pre-rotation sequence (S706), the discharge propriety discrimination and setting of the add time T_delta were made. In the embodiment 2, in the process of S903, the/TOP signal is outputted and the printing operation is started in accordance with a print reservation command for the first sheet, and thereafter, in S904, the engine controller 301 performs the discharge propriety discrimination. The discharge propriety discrimination in the embodiment 2 is different from that in the embodiment 1 in that the discharge propriety discrimination is made every page by using image information on a page for which the/TOP signal is outputted. Details of the discharge propriety discrimination in the embodiment 2 will be described later.

In S905, the engine controller 301 discriminates the discharge processing is needed. In the case where the engine controller 301 discriminated in S905 that the discharge processing is needed, the engine controller 301 causes the processing to go to S906. When the image formation interval controller 320 determines an image formation interval for a next page, the image formation interval controller 320 adjusts the interval so that an interval with which the discharge processing of the secondary transfer roller 9 can be executed even when the sheet absence occurs is ensured. In S906, the engine controller 301 sets, as the add time T_delta added to the normal image formation interval T_intvl, the discharge time T_cln when the engine controller 301 calculates an interval with the next page (T_delta=T_cln).

In the case where the engine controller 301 discriminated in S905 that the discharge processing is not discriminated, the engine controller 301 causes the processing to go to S907. In S907, the engine controller 301 sets the add time T_delta added to the normal image formation interval T_intvl to 0 since the interval with the next gage may be the normal image formation interval T_intvl (T_delta=0). The engine controller 301 waits for timing when a start of the printing operation for the next page is enabled in S908. The process of S907 is similar to the process using the formula (1) described in the embodiment 1.

FIG. 10B is a flowchart of discharge propriety discrimination described in S904 of FIG. 10A and performed by the propriety discriminating portion 350 after the/TOP signal for the associated page is outputted. Incidentally, processes S921 to S923, S925, and S926 of FIG. 10B are similar to S721 to S725, respectively, of part (b) of FIG. 8.

Before discrimination processing of S921, in S920, the propriety discriminating portion 350 discriminates whether or not a next page of the associated page is a back surface page. The discharge processing is performed for ensuring an interval for enabling execution of the discharge processing of the secondary transfer roller 9 between a front-surface toner image and a back-surface toner image. For this reason, in the case where the propriety discriminating portion 350 discriminated in S920 that the next page is the front surface (page), the propriety discriminating portion 350 causes the processing to go to S926, and a causes, for example, the RAM 209 to store that the discharge processing is not needed.

After discrimination that there is no designation is made in S923, in S924, the propriety discriminating portion 350 makes discrimination using image information of the associated page for which the/TOP signal is outputted. Here, the process of S924 is executed in the case where the next page is the back surface (page), and therefore, the associated page is the front surface (page) which is a preceding page of the next page. In S924, the propriety discriminating portion discriminates whether or not an average density of the associated page is a predetermined value or more. In the case where the propriety discriminating portion 350 discriminates in S924 that the average density of the associated page is the predetermined value or more, the propriety discriminating portion 350 causes the processing to go to S925, and in the case where the propriety discriminating portion 350 discriminated in S924 that the average density is less than the predetermined value, the propriety discriminating portion 350 causes the processing to go to S926.

When the sheet absence occurs at a page of which average density is high as in the case of a so-called solid image, even when the through voltage is applied to the secondary transfer roller 9, the amount of the reversely charged toner becomes larger than the amount of the normal toner. For that reason, in the case where the average density is high, the processing goes to S925, and the propriety discriminating portion 350 causes, for example, the RAM 209 to store that the discharge processing is needed. Incidentally, the image information in this embodiment is one obtained by analyzing image information received from the host computer 1000 by the video controller 204, and is notified every page from the video controller 204 to the engine controller 301. Further, the average density of the page is acquired as a proportion, in which the toner image is actually formed, to image formation resolution (for example, 600 dpi). Further, as regards discrimination of a predetermined value of the average density, the predetermined value is empirically determined from a correlation between the average density of the page and the amount of the reversely charged toner deposited on the secondary transfer roller 9 after the through voltage is applied to the page. For example, in the embodiment 2, the average density is discriminated as 80% or more. That is, the predetermined value in the discrimination processing of S924 is 80%, and the propriety discriminating portion 350 discriminates that the discharge processing is “needed” in the case where the average density is the predetermined value or more (80% or more). On the other hand, the propriety discriminating portion 350 discriminates that the discharge processing is “not needed” in the case where the average density is less than the predetermined value (less than 80%).

### (Sequence Using Propriety Discrimination of Discharge Processing in Embodiment 2)

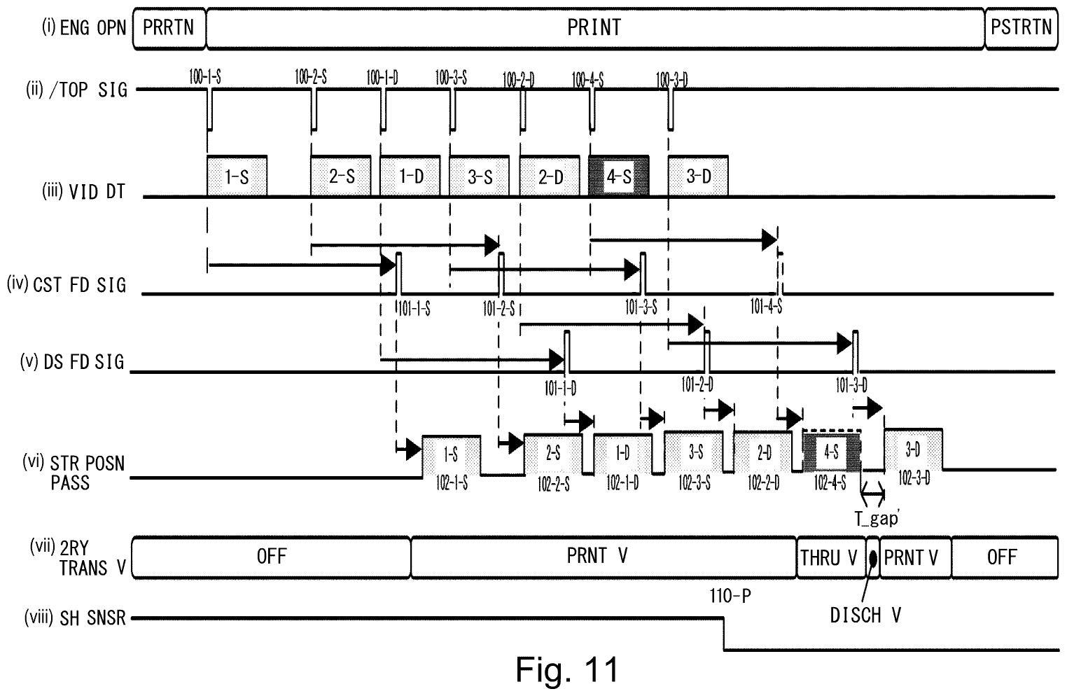

FIG. 11 is an image forming sequence in the case where the absence of the sheet 2 in the cassette 1 occurs at the fourth sheet similarly as in the case of FIG. 6 and thus printing cannot be continued, and in which processing in accordance with a flow described with reference to FIG. 10 is performed. Incidentally, (i) to (vii) of FIG. 11 are similar to those of FIG. 7. In “(iii) video data” and “(vi) secondary transfer roller position passing” of FIG. 11, a state in which the average density of the page is high (thick) only for the fourth-sheet front surface (4-S) and is low (thin) for other pages is shown.

The average density of the page to the second-sheet back surface (2-D) is low. For this reason, in accordance with S924 of the flowchart in the embodiment 2 described with reference to FIG. 10, between the second-sheet front surface (2-S) and the first-sheet back surface (1-D) and between the third-sheet front surface (3-S) and the second-sheet back surface (2-D), discrimination that the discharge processing is not needed is made during the sheet absence. Accordingly, on these pages, the images are printed with the normal image formation interval. Even if the sheet absence occurs at either one of these pages, the discharge processing is not needed during the sheet absence, and therefore, similarly as the sequence diagram of FIG. 6, it is predicted that the backside contamination does not occur only by application of the through voltage.

On the other hand, the average density of the fourth-sheet front surface is high, and therefore, between the fourth-sheet front surface (4-S) and the third-sheet back surface (3-D), discrimination that the discharge processing is made. Accordingly, as an interval between these pages, an interval T_tap′ longer than the normal image formation interval is ensured, so that in the case where the sheet absence occurs at the fourth sheet, it becomes possible to execute the discharge processing after the through voltage is applied.

Incidentally, in the discharge propriety discrimination in FIG. 10B, an example in which the discrimination processing of S924, the average density of the page is used as the image information was described. As regards the image information, as another information, it would be considered that the following information is utilized.

### [Maximum Value of Toner Density Calculated for Each Region in Page]

A page is divided into a plurality of regions, and the propriety discriminating portion 350 acquires the toner density per unit area for each region. In the case where the toner density per unit area in either one of the regions is extremely high, the propriety discriminating portion 350 discriminates that a patch of the so-called solid image is formed, and discriminates that the discharge processing is needed.

### [Whether or not Image in Page is Only Test (Image)]

When the image in the page is only a text (image), the propriety discriminating portion 350 discriminates that the discharge processing is not needed, and when the image includes an image other than the text, the propriety discriminating portion 350 discriminates that the discharge processing is needed.

The propriety discriminating portion 350 may also discriminate whether or not the discharge processing is needed during the sheet absence, by using the image information as described above.

Thus, to the predetermined condition, in addition to conditions that the environment temperature is the predetermined temperature or more, that the remaining life time is less than the predetermined value, that the designation of the second operation by the user is made, and that the image density in the immediately-before printing is the predetermined value or more, the following condition may also be added. That is, the predetermined condition may also include that the image in the immediately-before printing includes the image other than the text and that the maximum density of a part of the regions in the immediately-before printing is the predetermined value or more. Further, the predetermined condition may include at least one of these conditions. That is, the predetermined condition may also be one of these conditions.

For example, when the designation of the second operation by the user is made, the second operation may be executable, and when the designation of the second operation by the user is not made, the first operation may be executable. In other words, only when the designation of the second operation by the user is made, the second operation may be executable, and when the designation of the second operation by the user is not made, the first operation my always be executable.

By the above, according to the embodiment 2, whether or not there is a possibility that the level of the backside contamination cannot be suppressed to the allowable level or less even when the through voltage is applied in the case where the sheet absence occurs during execution of the double-sided, is discriminated every page with use of the image information. By this, the interval with which the discharge processing of the secondary transfer roller 9 can be performed is ensured by adjusting the image formation start timing only between necessary pages, and further, it becomes possible to prevent the backside contamination while suppressing a lowering in productivity.

As described above, according to the embodiment 2, it is possible to suppress a lowering in productivity during the double-sided printing.

### Embodiment 3

In the embodiment 3, a further modified example of the discharge propriety discrimination using the image information described in the embodiment 2 is shown. In the embodiment 2, whether or not the discriminate processing is needed in the case where the sheet absence occurs was discriminated by the flowchart of the discharge propriety discrimination in FIG. 10B. Further, in the case where discrimination that the discharge processing is needed is made, the discharge time T_cln of the secondary transfer roller 9 is set as the add time T_delta added to the normal image formation interval T_intvl. Here, in the case where a margin on a trailing end side of the associated page (hereinafter, also referred to as a present page) is larger than a predetermined value even if the discharge processing is discriminated as being needed in the discharge propriety discrimination, an image interval with a subsequent back surface image substantially becomes large. For this reason, not less than the interval T_gap′ necessary for the discharge processing is ensured. By this, in the case where the sheet absence occurs, it becomes possible that the discharge processing is performed after the through voltage is applied, so that the add time T_delta added to the normal image formation interval is not needed. In other words, in the case where a margin between the trailing end of the toner image formed in the immediately-before printing and an objective sheet is longer than a predetermined length, even when the predetermined conditioned is satisfied, the engine controller 301 is capable of executing the first operation.

### (Discharge Propriety Discrimination Processing in Embodiment 3)

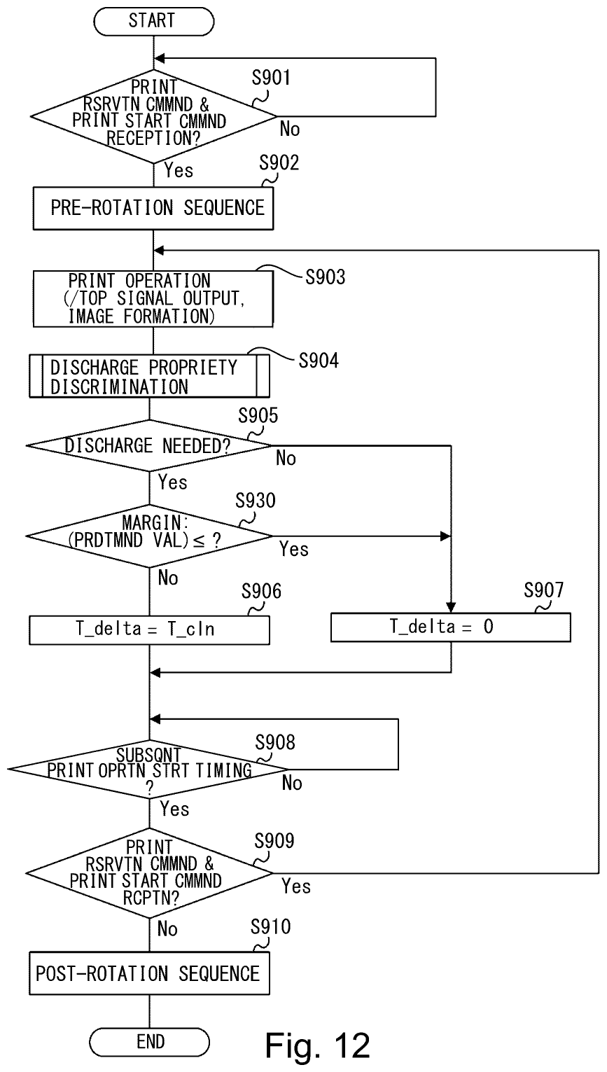

FIG. 12 is a flowchart of a printing operation of the engine controller 301 in the embodiment 3. In FIG. 12, the printing operation is different from the printing operation in FIG. 10A in that discrimination processing of S930 is added after the process of S905, and other processes will be omitted from description by adding the same step numbers as those in FIG. 10A.

When discrimination that the discharge processing is needed is made in S905, in S930, the engine controller 301 discriminates whether or not a margin of the associated page on a trailing end side (hereinafter, this margin is referred to as a trailing end margin) is a predetermined value or more. That is, the engine controller 301 performs discrimination using a margin amount of the present page on a trailing end side (hereinafter, referred to as a page trailing end side) as image information of the associated page (present page) for which the/TOP signal is outputted. Information of the margin amount of the present page on the trailing end side is acquired by analyzing image information received from the host computer 1000 by the video controller 204 similarly as in the embodiment 2, and is notified every page from the video controller 204 to the engine controller 301.

In the case where a margin amount T_margin on the page trailing end side is longer (higher) than a predetermined value (for example, a peripheral length of the secondary transfer roller 9), as described above, an image interval with a subsequent back surface image substantially becomes large. For this reason, in the case here the engine controller 301 discriminated in S930 that the trailing end margin of the associated page becomes a predetermined value or more, the processing goes to S907. That is, even when the discharge processing is discriminated as being needed in the discharge propriety discrimination of S904, in the case where the margin amount on the page trailing end side is large, the processing goes to S907, and the engine controller 301 sets 0 as the add time T_delta in S907. In the case where the engine controller 301 discriminated in S930 that the trailing end margin of the associated page is less than the predetermined value, the engine controller 301 causes the processing to go to S906 in order to ensure a time for the discharge processing.

Thus, in the case where the predetermined value is, for example, the peripheral length of the secondary transfer roller 9 and the margin amount T_margin is the predetermined value or more (the peripheral length or more of the secondary transfer roller 9), the engine controller 301 sets 0 as the add time T_delta (S907). On the other hand, when the margin amount T_margin is less than the predetermined value (the peripheral length of the secondary transfer roller 9), the engine controller 301 sets the discharge time T_cln as the add time T_delta (S906). Subsequent processes are similar to those in the embodiment 2. Incidentally, the margin amount T_margin is represented as the time depending on the conveying speed, but may also be represented as a distance (L_margin).

### (Sequence Using Propriety Discrimination of Discharge Processing in Embodiment 3

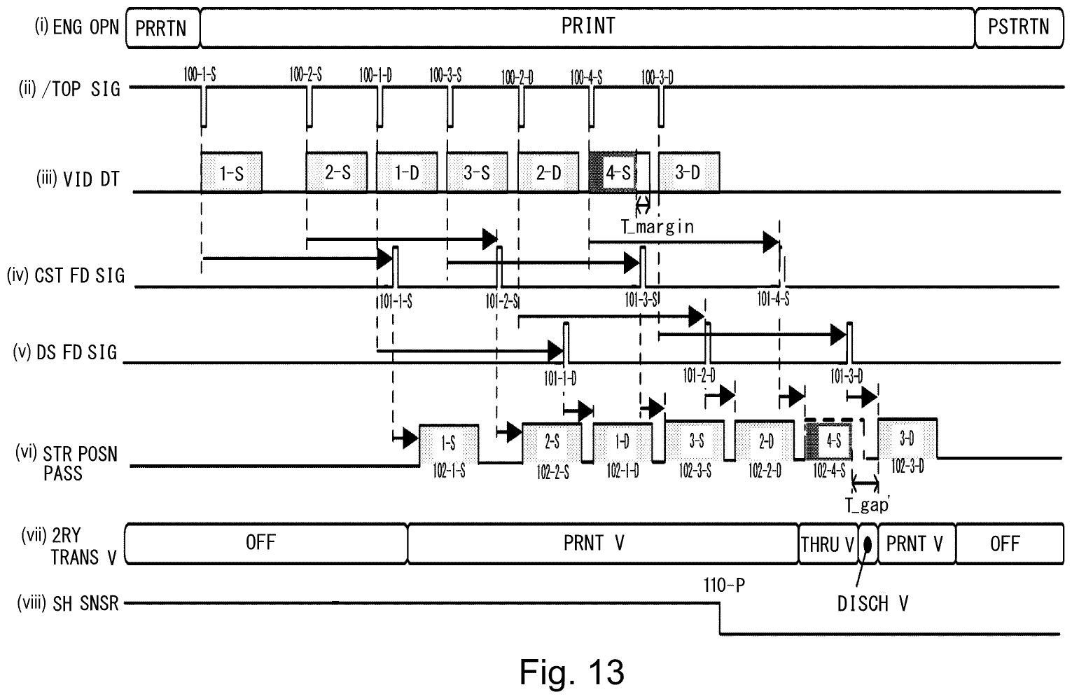

FIG. 13 is an image forming sequence in the case where the absence of the sheet 2 in the cassette 1 occurs at the fourth sheet similarly as in the case of FIG. 11 and thus printing cannot be continued, and in which processing in accordance with a flow described with reference to FIG. 12 is performed. Incidentally, (i) to (vii) of FIG. 13 are similar to those of FIG. 7. In “(iii) video data” and “(vi) secondary transfer roller position passing” of FIG. 13, a state in which the average density of the page is high only for the fourth-sheet front surface (4-S) and is low for other pages is shown. Further, in a trailing end portion of the fourth-sheet front surface, there is a margin region having a margin amount T_margin longer than the peripheral length of the secondary transfer roller 9.

In accordance with the flowchart of FIG. 12, between the toner image 4-S on the fourth-sheet front surface and the toner image 3-D on the third-sheet back surface, discrimination that the discharge processing is needed during the sheet absence is made by the flowchart of FIG. 10B. However, the image interval including the trailing end margin is long in the discrimination of S930, and therefore, the engine controller 301 causes the processing to go to S907, and printing is performed with the normal image formation. Even when the sheet absence is detected at the fourth sheet by the sheet sensor 11, a long interval T_gap′ has already been ensured in the secondary transfer roller position so that the discharge processing can be performed after the through voltage is applied. Incidentally, the interval T_gap′ in the embodiment 3 includes the margin amount T_margin as shown in (vi) of FIG. 13.

As described above, according to the embodiment 3, in the case where the interval with which the discharge processing of the secondary transfer roller 9 can be performed by using the margin information of the page trailing end as the image information, the image formation timing is kept as the normal image formation interval. For that reason, it becomes possible to prevent the backside contamination while further suppressing the lowering in productivity.

As described above, according to the embodiment 3, the lowering in productivity during the double-sided printing can be suppressed.

### Embodiment 4

In the embodiments 1 to 3, when the image formation interval during the printing operation is determined, propriety discrimination of the discharge processing for avoiding the backside contamination during the sheet absence is performed, and in the case where the discharge processing for avoiding the backside contamination during the sheet absence is discriminated as being needed, the image formation interval with which the discharge processing can be performed was set. That is, in the case where discrimination that the level of the backside contamination cannot be suppressed to the allowable level or less is made, the image formation interval was increased irrespective of actual occurrence of the sheet absence. In other words, control for providing the image interval is carried out in advance so that the discharge processing can be performed when the sheet absence actually occurred, so that an interval with which the discharge processing can be performed even when the sheet absence does not actually occur was provided.

In the embodiment 4, the propriety discrimination of the discharge processing for avoiding the backside contamination when the sheet absence actually occurred is made, and depending on a discrimination result thereof, a processing operation after the occurrence of the sheet absence is determined. Specifically, when the sheet absence actually occurred during the double-sided printing, depending on the sheet interval of the page at which the sheet absence occurred and on a propriety discrimination result of the discharge processing for avoiding the backside contamination, propriety of the discharge processing of the toner deposited on the secondary transfer roller 9 and an execution timing of the discharge processing are determined. Incidentally, the sheet interval means a distance between a trailing end of a preceding sheet and a leading end of a subsequent sheet or a time depending on the distance. In this embodiment, the processing operation after the occurrence of the sheet absence is determined during the occurrence of the sheet absence, and therefore, it becomes possible to prevent the backside contamination further suppressing the lowering in productivity.

### (Functional Block)

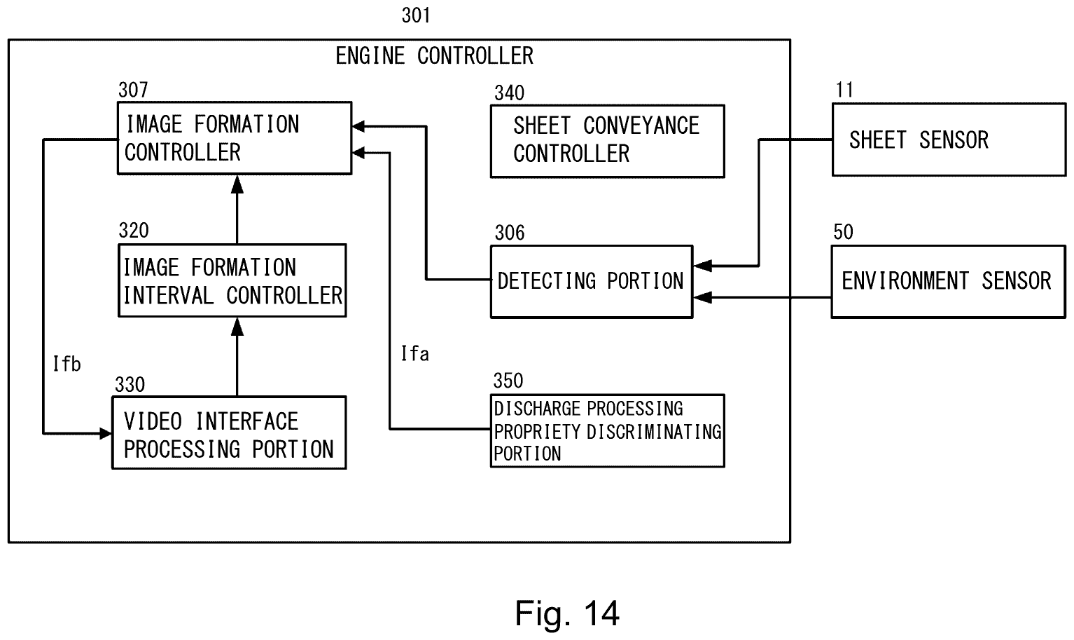

Next, a functional black in the embodiment 4 will be described using FIG. 14. In this embodiment, only a portion relating to the embodiment 4 is extracted and described. In the case where the sheet absence is detected by the detecting portion 306, the image formation controller 307 in the embodiment 4 performs the following determination. That is, the image formation controller 307 determines a processing operation after the sheet absence depending on a sheet interval of a page, at which the sheet absence occurs (hereinafter, this page is referred to as a sheet absence occurrence page, controlled by the image formation interval controller 320 and propriety of the discharge processing for avoiding the backside contamination discriminated by the propriety discriminating portion 350.

Here, in FIG. 14, differences from FIG. 3 are that information Ifa is notified from the propriety discriminating portion 350 to the image formation controller 307 and that information Ifb is notified from the image formation controller 307 to the video interface processing portion 330. The information Ifa is information (information determined by the flowchart of FIG. 10B) on whether or not the discharge processing of the secondary transfer roller 9 is needed in the case where the sheet absence occurs. The information Ifb is information including processing requests on reservation, such as a cancel request of print reservation on sheets subsequent to the sheet absence occurrence page, and a reprint operation request on a final back surface page to the video controller 204, when the sheet absence is detected by the sheet sensor 11. Post-processing after the sheet absence will be described later. Incidentally, the final back surface page is a back surface page after the page at which the sheet absence is detected and is a back surface page on which the toner image is formed. For example, in the case where the sheet absence occurs at the fourth sheet 2 as in the above-described embodiments, the final back surface page is the back surface of the third sheet 2.

(Processing Operation after Sheet Absence)

The image formation controller 307 in the embodiment 4 determines the processing operation after the discharge processing for avoiding the backside contamination during the occurrence of the sheet absence. In the embodiment 4, the image formation controller 307 selects three processing operations after the sheet absence depending on a situation.

(First Processing Operation after Sheet Absence: First Operation)

The first is a processing operation selected in the case where the discharge processing for avoiding the backside contamination is not needed during the occurrence of the sheet absence. Specifically, the engine controller 301 first applies the through voltage to the secondary transfer roller 9 when the toner image corresponding to the sheet absence occurrence page passes through the secondary transfer roller 9. Thereafter, the print voltage is applied to the secondary transfer roller 9 when the toner image corresponding to the final back surface page passes through the secondary transfer roller 9, and then the sheet 2 on which the toner image corresponding to the final back surface page is transferred is discharged. That is, in the first processing operation (first position), the discharge processing is not performed, and the toner image corresponding to the final back surface page is transferred on the sheet 2, so that double-sided printing of this sheet 2 is completed.

That is, in this operation, the toner image formed in the back surface printing is transferred on the re-conveying sheet.

(Second Processing Operation after Sheet Absence: Second Operation)

The second is a processing operation selected in the case where the discharge processing for avoiding the backside contamination is needed during the occurrence of the sheet absence, and where a time necessary for the discharge processing of the secondary transfer roller 9 can be ensured in the sheet interval. Specifically, the engine controller 301 first applies the through voltage to the secondary transfer roller 9 when the toner image corresponding to the sheet absence occurrence page passes through the secondary transfer roller 9. Next, the discharge voltage is applied until the time necessary for the discharge processing 9 for discharging the toner deposited on the secondary transfer roller 9 has elapsed. Finally, the print voltage is applied to the secondary transfer roller 9 when the toner image corresponding to the final back surface page passes through the secondary transfer roller 9, and then the sheet 2 on which the toner image corresponding to the final back surface page is transferred is discharged.

That is, in this operation, the cleaning operation of the secondary transfer roller 9 is performed before the toner image formed in the back surface printing reaches the secondary transfer portion, and then the toner image formed in the back surface printing is transferred on the re-conveying sheet.

(Third Processing Operation after Sheet Absence: Third Operation)

The third is a processing operation selected in the case where the discharge processing for avoiding the backside contamination is needed during the occurrence of the sheet absence, and where the time necessary for the discharge processing of the secondary transfer roller 9 cannot be ensured in the sheet interval.

Specifically, an interval necessary for the discharge processing cannot be ensured in a sheet interval between the sheet absence occurrence page and the final back surface page. For this reason, the engine controller 301 first applies the through voltage to the secondary transfer roller 9 when the toner image corresponding to the sheet absence occurrence page and the toner image corresponding to the final back surface page pass through the secondary transfer roller 9.

Next, the engine controller 301 applies the discharge voltage until a time necessary for discharging the toner deposited on the secondary transfer roller 9 has elapsed. Finally, the engine controller 301 performs reprinting operation of the image on the final back surface page through the video interface processing portion 330, and then the sheet 2 on which the image for the final back surface page is transferred is discharged to the outside of the image forming apparatus. That is, in the third processing operation (third operation), the toner image formation on the final back surface page is carried out again, in other words, the operation is performed again from the output of the/TOP signal. This operation is referred to as the reprinting operation.

As described above, in this operation, the cleaning operation is performed after the toner image formed in the back surface printing passes through the secondary transfer portion, and the toner image formed by executing the back surface printing again is transferred onto the re-conveying sheet.

As described above, the engine controller 301 in the embodiment 4 is constituted so that the first operation is executable in the case where the predetermined condition is not satisfied and so that the second operation or the third operation is executable depending on an interval between the immediately-before printing and the back surface printing in the case where the predetermined condition is satisfied. Specifically, in the case where the interval between the immediately-before printing and the back surface printing is a length in which the cleaning operation is executable, the second operation is executed, and in the case where the interval between the immediately-before printing and the back surface printing is not a length in which the cleaning operation is executable, the third operation is executed. The predetermined condition is similar to the predetermined condition in the above-described embodiments. Further, in the case where the sheet absence occurred, the through processing in which the toner image formed in the immediately-before printing passes through the secondary transfer portion is executed before the associated operation even when either one of the first operation, the second operation, and the third operation is performed.

### (Sheet Absence Discrimination and Sheet Absence Post-Processing Discrimination in FIG. 4)

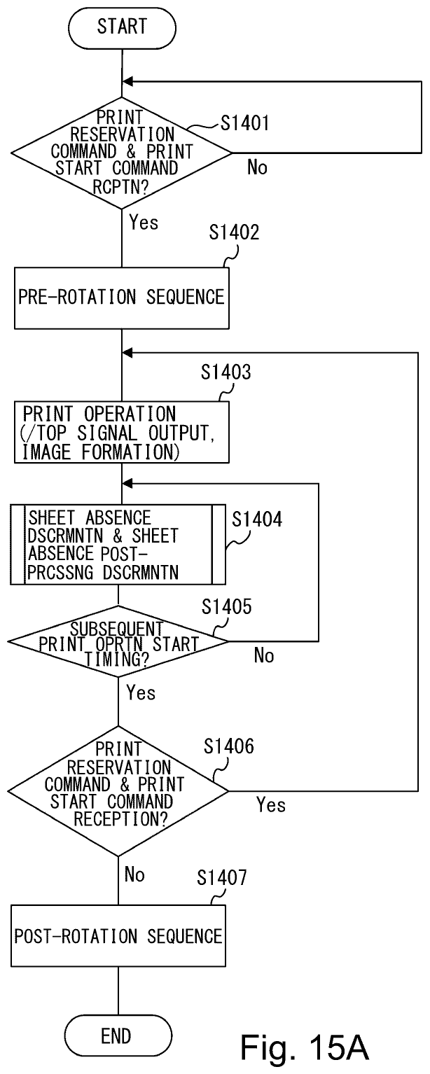

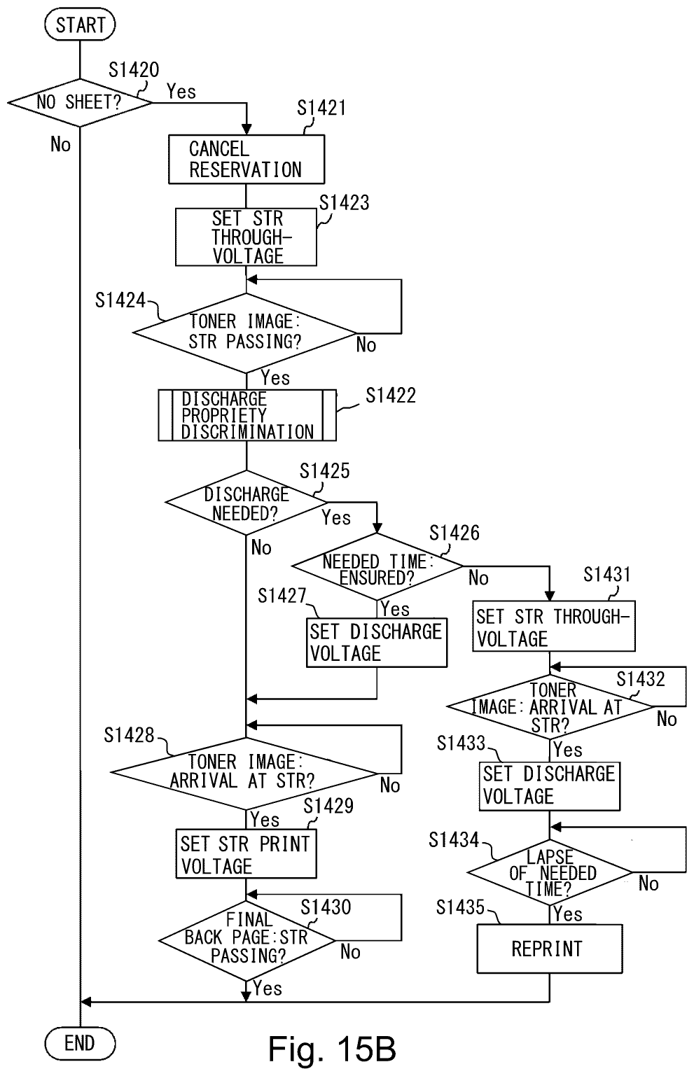

FIG. 15A is a flowchart of the printing operation of the engine controller 301 in the embodiment 4. Incidentally, processes S1401 to S1403, and S1405 to S1407 are similar to the processes S901 to S903, and S908 to S910, respectively, in FIG. 10, and will be omitted from description. The engine controller 301. In S1403, the engine controller 301 starts the printing operation such as output of the/TOP signal, and during waiting of a timing enabling a start of a subsequent printing operation in S1405, the engine controller 301 executes the sheet absence discrimination and the processing operation discrimination after the sheet absence in S1404. Incidentally, in the case where the engine controller 301 discriminated in S1405 that the timing is not the timing of the subsequent printing operation, the engine controller 301 causes the processing to return to S1404.

FIG. 15B is a flowchart of the sheet absence discrimination and the sheet absence post-processing discrimination which are described in S1404 of FIG. 15A, and which are performed by the image formation controller 307. In S1420, the image formation controller 307 discriminates whether or not the sheet absence occurred, on the basis of a detection result of the sheet sensor 11. In the case where the image formation controller 307 discriminated in S1420 that the sheet absence does not occur, the image formation controller 307 ends the processing.

In the case where the image formation controller 307 discriminated in S1420 that the sheet absence occurred, the image formation controller 307 causes the processing to go to S1421. In S1421, the image formation controller 307 cancels reservation of sheets subsequent to the sheet absence occurrence page. For example, in the case where the sheet absence occurred at the fourth sheet, reservation of a fifth sheet and later is cancelled. The image formation controller 307 requests cancellation of print reservation for the sheets subsequent to the sheet absence occurrence page through the video interface processing portion 330. By this, the video controller 204 cancels reservation for pages other than the final back surface page discharged to the outside of the image forming apparatus.

In S1423, the image formation controller 307 causes the secondary transfer power source 41 to apply the through voltage to the secondary transfer roller 9 for passing, through the secondary transfer roller 9, the toner image corresponding to the page at which the sheet absence occurred.

In S1424, the image formation controller 307 discriminates whether or not the toner image corresponding to the sheet absence occurrence page passed through the secondary transfer roller 9. In S1424, the image formation controller 307 causes the processing to return to S1424 in the case where the image formation controller 307 discriminated that the toner image corresponding to the sheet absence occurrence page does not pass through the secondary transfer roller 9, and causes the processing to go to S1422 in the case where the toner image corresponding to the sheet absence occurrence page passed through the secondary transfer roller 9. In S1422, the image formation controller 307 performs the discharge propriety discrimination. The discharge propriety discrimination during the sheet absence is the same processing as the flowchart described in the embodiment 2 with reference to FIG. 10B. The propriety discriminating portion 350 sets the propriety of the discharge processing on the basis of whether or not the next page is the back surface, whether or not the installation environment is the high-temperature (environment), whether or not the cartridge life time reaches the end thereof, whether or not there is the user designation for preventing the backside contamination, and/or whether or not the average density of the associated page is the predetermined value or more.

In S1425, on the basis of a discrimination result of S1422, the image formation controller 307 discriminates whether or not the discharge processing during the sheet absence is needed. In the case where the image formation controller 307 discriminated in S1425 that the discharge processing is “not needed”, the image formation controller 307 causes the processing to go to S1428. In S1428, the image formation controller 307 discriminates whether or not the toner image corresponding to the final back surface page reaches (arrives at) the secondary transfer roller 9. In S1428, the image formation controller 307 causes the processing to return to S1428 in the case where the image formation controller 307 discriminated that the toner image corresponding to the final back surface page does not reach the secondary transfer roller 9, and causes the processing to go to S1429 in the case where the image formation controller 307 discriminated that the toner image corresponding to the final back page reaches the secondary transfer roller 9. In S1429, the image formation controller 307 causes the secondary transfer power source 41 to apply the print voltage to the secondary transfer roller 9 in order to perform the printing operation of the image on the final back surface page. In S1430, the image formation controller 307 discriminates whether or not the final back surface page passed through the secondary transfer roller 9. In S11430, the image formation controller 307 causes the processing to return to S1430 in the case where the image formation controller 307 discriminated that the final back surface page does not pass through the secondary transfer roller 9, and ends the processing in the case where the image formation controller 307 discriminated that the final back surface page passed through the secondary transfer roller 9. This series of processes corresponds to the first processing operation (first operation) of the above-described three processing operations after the sheet absence.

In S1425, in the case where the image formation controller 307 discriminated on the basis of a discrimination result of S1422 that the discharge processing during the sheet absence is “needed”, the image formation controller 307 causes the processing to go to S1426. In S1426, the image formation controller 307 discriminates whether or not a time needed for the discharge processing can be ensured in a sheet interval of the sheet absence occurrence page. In the case where the image formation controller 307 discriminated in S1426 that the needed time can be ensured, the image formation controller 307 causes the processing to go to S1427. In S1427, the image formation controller 307 causes the secondary transfer power source 41 to apply the discharge voltage to the secondary transfer roller 9 until the time needed for the discharge processing in order to avoid the backside contamination. The time needed for the discharge processing in the embodiment 4 is a time in which the secondary transfer roller 9 can be rotated by an angle corresponding to not less than a peripheral length of the secondary transfer roller 9 in a state in which the discharge voltage is applied to the secondary transfer roller 9, but is not limited thereto. This series of processes corresponds to the second processing operation (second operation) of the above-described three processing operations after the sheet absence.

In S1426, in the case where the image formation controller 307 discriminated that the time needed for the discharge processing cannot be ensured in the sheet interval of the sheet absence occurrence page, the image formation controller 307 causes the processing to go to S1431. In S1431, the image formation controller 307 causes the secondary transfer power source 41 to apply the through voltage to the secondary transfer roller 9 in order to pass the toner image, corresponding to the final back surface page, through the secondary transfer roller 9. IN S1432, the image formation controller 307 discriminates whether or not the toner image corresponding to the final back surface page passed through the secondary transfer roller 9. In S1432, the image formation controller 307 causes the processing to return to S1432 in the case where the image formation controller 307 discriminated that the toner image corresponding to the final back surface page does not pass through the secondary transfer roller 9, and causes the processing to go to S1433 in the case where the toner image corresponding to the final back surface page passed through the secondary transfer roller 9.

In S1433, the image formation controller 307 causes the secondary transfer power source 41 to apply the discharge voltage to the secondary transfer roller 9. In S1434, the image formation controller 307 discriminates whether or not the time needed for the discharge processing has elapsed. In S1434, the image formation controller 307 causes the processing to return to S1434 in the case where the image formation controller 307 discriminates that the needed time has not elapsed, and causes the processing to go to S1435 in the case where the image formation controller discriminated that the needed time has elapsed. In S1435, the image formation controller 307 requests a reprinting operation for the final back surface page to the video controller 204 through the video interface processing portion 330 and performs the printing operation of the image on the final back surface page, and then ends the processing. This series of processes corresponds to the third processing operation (third operation) of the above-described three processing operations after the sheet absence.

### (Sequence Using Sheet Absence Discrimination and Sheet Absence Post-Processing Discrimination in Embodiment 4)

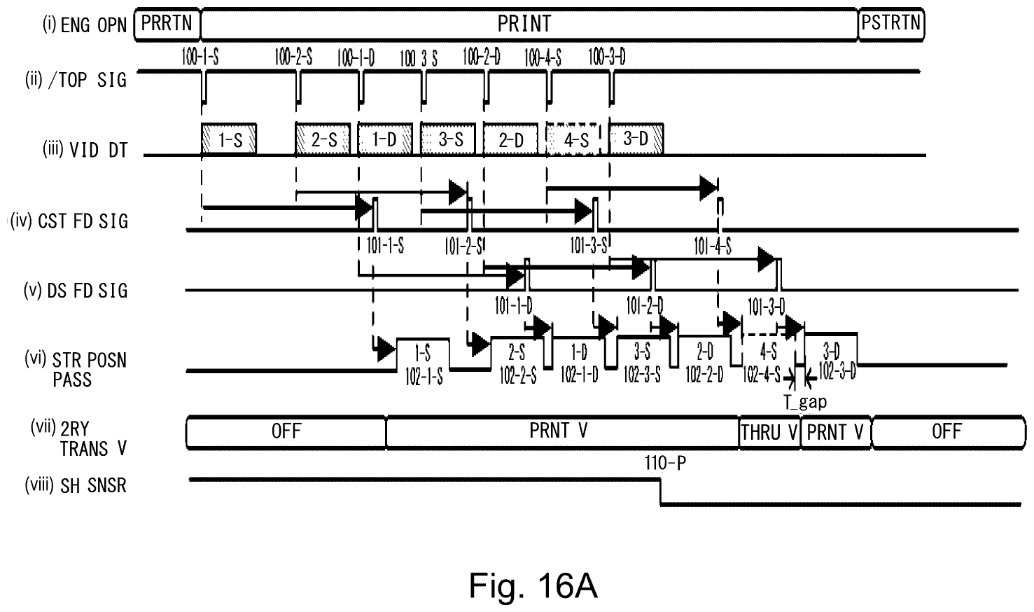

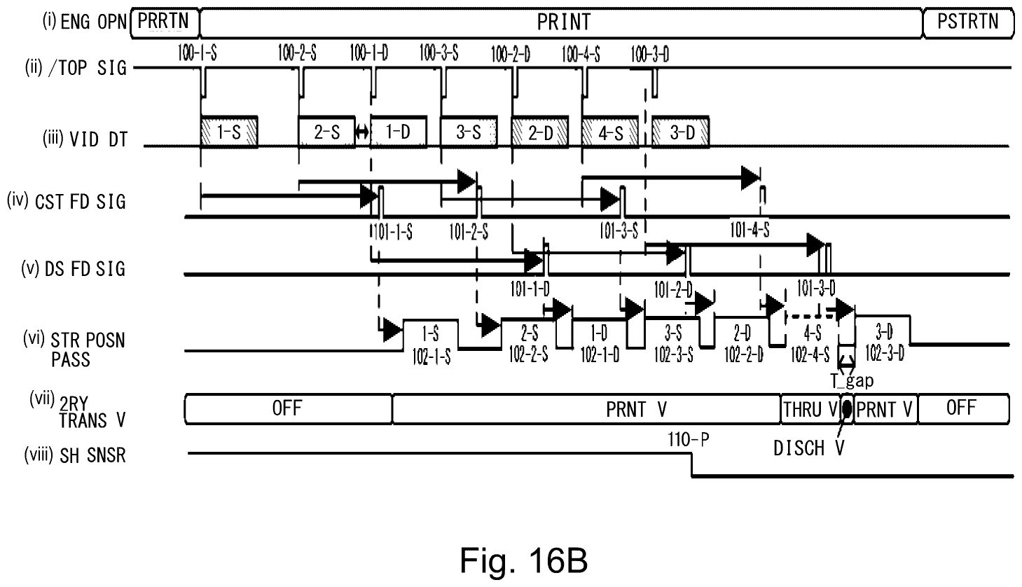

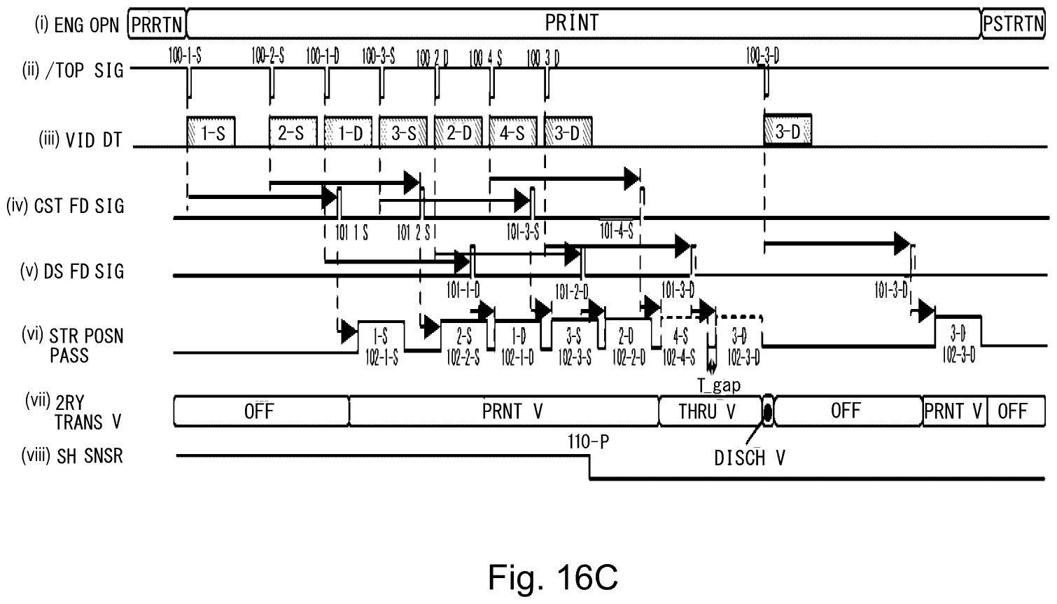

FIG. 16A is a processing operation sequence after the sheet absence in accordance with the flowchart, in the case where the discharge processing for avoiding the backside contamination is not needed during the sheet absence occurrence described with reference to FIG. 15. That is, this sequence is the above-described first case (first operation).

Description of reference numerals or symbols in FIG. 16A are similar to the description in FIG. 7. A timing when the absence of the fourth sheet in the cassette 1 is detected by the sheet sensor 11 is the timing 110-P. As shown in (ii) of FIG. 16A, at the timing 110-P, formation of the image on the fourth-sheet front surface has already been finished by outputting the/TOP signal (100-4-S) for the fourth-sheet front surface. Further, formation of the image on the subsequent third-sheet back surface is started by outputting the/TOP signal (100-3-D) for the subsequent third-sheet back surface.

The following processing is performed for normally printing the image on the third-sheet back surface without wasting the third sheet 2 subjected to one-sided printing. That is, as shown in (vii) of FIG. 16A, the through voltage is applied to the secondary transfer roller 9 until the toner image on the fourth-sheet front surface passes through the secondary transfer portion (102-4-S). Thereafter, as shown in (vii) of FIG. 16A, the print voltage is applied to the secondary transfer roller 9 until the toner image on the third-sheet back surface passes through the secondary transfer portion (102-3-D), and then the sheet 2 on which the toner image corresponding to the third-sheet back surface is transferred is discharged to the outside of the image forming apparatus.

FIG. 16B is a processing operation sequence after the sheet absence in accordance with the flowchart, in the case where the discharge processing for avoiding the backside contamination is needed during the sheet absence occurrence and where the time needed for the discharge processing of the secondary transfer roller 9 can be ensured in the sheet interval, described with reference to FIG. 15. That is, this sequence is the above-described second case (second operation).

Reference numerals or symbols in FIG. 16B are similar to those in FIG. 7, and a difference of FIG. 16B from FIG. 16A will be described. In FIG. 16B, the through voltage is applied to the secondary transfer roller 9 until the toner image on the fourth-sheet front surface passes through the secondary transfer portion (102-4-S) ((vii) of FIG. 16B). Thereafter, the discharge voltage is applied to the secondary transfer roller 9 in order to discharge the toner deposited on the secondary transfer roller 9. In FIG. 16B, it is assumed that the time needed for the discharge processing of the secondary transfer roller 9 can be ensured by the time T_gap corresponding to the sheet interval L_gap. Thereafter, the print voltage is applied to the secondary transfer roller 9 until the toner image on the third-sheet back surface passes through the secondary transfer portion (102-3-D), and then the sheet 2 on which the toner image for the third-sheet back surface is transferred is discharged to the outside of the image forming apparatus.

FIG. 16C is a processing operation sequence after the sheet absence in accordance with the flowchart, in the case where the discharge processing for avoiding the backside contamination is needed during the sheet absence occurrence and where the time needed for the discharge processing of the secondary transfer roller 9 cannot be ensured in the sheet interval, described with reference to FIG. 15. That is, this sequence is the above-described third case (third operation).

Reference numerals or symbols in FIG. 16C are similar to those in FIG. 7, and a difference of FIG. 16B from FIGS. 16A and 16B will be described. In FIG. 16C, a discharging time needed for avoiding the backside contamination cannot be ensured in the time T_gap between the fourth-sheet front surface and the third-sheet back surface. For this reason, the through voltage is applied to the secondary transfer roller 9 until both the toner image on the fourth-sheet front surface and the toner image on the third-sheet back surface pass through the secondary transfer portion (102-4-S, 102-3-D) ((vii) of FIG. 16C). Thereafter, the discharge voltage is applied to the secondary transfer roller 9 in order to discharge the toner deposited on the secondary transfer roller 9. Thereafter, the image formation controller 307 requests the reprinting operation for the third-sheet back surface to the video controller 204 through the video interface processing portion 330, so that the processing operation for the third-sheet back surface is executed (second 100-3-D).

As described above, according to the embodiment 4, in the case where the sheet absence occurs during execution of the double-sided printing, in a situation such that there is a possibility that the level of the backside contamination cannot be suppressed to the allowable level or less even under application of the through voltage, depending on the sheet interval of the sheet absence occurrence page, a timing of the discharge processing after the occurrence of the sheet absence is changed. By this, the discharge processing is executed only when the sheet absence occurred, and therefore, it becomes possible to prevent the backside contamination while further suppressing the lowering in productivity. Incidentally, also in the embodiment 4, in S1422 of FIG. 15B, the modified examples, such as the maximum value of the density and whether or not the image is the text, described in the embodiment 2 are applicable.

As described above, according to the embodiment 4, the lowering in productivity during the double-sided printing can be suppressed.

### Embodiment 5

In an embodiment 5, further modified example relating to the discrimination of the processing operation after the sheet absence described in the embodiment 4 is described. In the embodiment 4, the processing operation after the sheet absence in the case where in the flowchart of the processing operation after the sheet absence of FIG. 15B, the discharge processing for avoiding the backside contamination is needed during the occurrence of the sheet absence and the sheet interval needed for the discharge processing of the secondary transfer roller 9 cannot be ensured was described. Specifically, the sheet interval between the sheet absence occurrence page and the subsequent final back surface page is short (narrow), and thus a time needed for the discharge processing of the secondary transfer roller 9 cannot be ensured, and therefore, the through voltage was applied to the sheet absence occurrence page and the subsequent final back surface page. Thereafter, the discharge voltage for not less than the time needed for the discharge processing of the secondary transfer roller 9 was applied, and the reprinting operation for the subsequent final back surface page was performed.

In the embodiment 5, in the case of the sheet interval such that the sum of a trailing end margin and a sheet interval in the sheet absence occurrence page can ensure the time needed for the discharge processing even when the sheet interval needed for the discharge processing for avoiding the backside contamination, the discharge processing for avoiding the backside contamination between image is executed. By this, the discharge processing can be executed between the sheet absence occurrence page and the subsequent final back surface paper without performing the reprinting operation for the subsequent final back surface page, so that it becomes possible to prevent the backside contamination while suppressing the lowering in productivity.

### (Sheet Absence Processing Discrimination and Sheet Absence Post-Processing Discrimination in Embodiment 5)

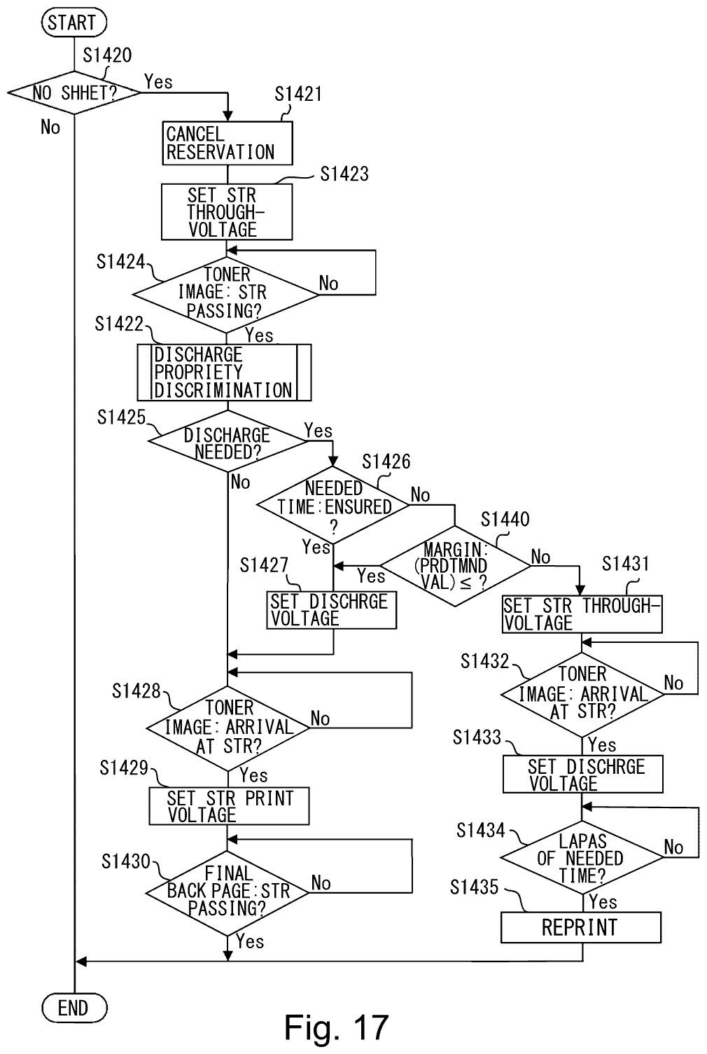

FIG. 17 is a flowchart of the processing operation after the sheet absence in the embodiment 5, and the processing operation is executed by the image formation controller 307. In FIG. 17, a process of S1440 is added after the process of S1426, and thus is different from the processing operation of FIG. 15B. Other processes will be omitted from description by adding the same step numbers as those in FIG. 15B.

In S1426, in the case where discrimination that the time needed for the discharge processing cannot be executed in the sheet interval is made, in S1440, the image formation controller 307 makes discrimination using a margin amount of the sheet absence occurrence page on a trailing end side. That is, in S1440, the image formation controller 307 discriminates whether or not the trailing end margin of the sheet absence occurrence page is a predetermined value or more. Information on the margin amount is, similarly as in the embodiment 3, obtained by analyzing the image information received from the host computer 1000 by the video controller 204 and is notified every page from the video controller 204 to the engine controller 301.

In S1440, in the case where the image formation controller 307 discriminated that a margin amount T_margin of the sheet absence occurrence page on the trailing end side is a predetermined value or more, the image formation controller 307 causes the processing to go to S1427. In this case, an image interval with the subsequent back surface image substantially becomes large, and therefore, it becomes possible to execute the discharge processing between the sheet absence occurrence page and the subsequent back surface page. The predetermined value in the embodiment 5 is the peripheral length of the secondary transfer roller 9. For that reason, even when discrimination that the sheet interval of the sheet absence occurrence page cannot ensure the time needed for the discharge processing is made, in the case where the margin amount T_margin on the trailing end side of the page is large, the processing goes to the process of S1427, and the discharge voltage is set.

In S1440, in the case where the image formation controller 307 discriminated that the trailing end margin is less than the predetermined value, the image formation controller 307 causes the processing to go to $1431. Subsequent processes are similar to those in the embodiment 4. Thus, in the case where the predetermined value is, for example, the peripheral length of the secondary transfer roller 9 and the margin amount T_margin is not less than the predetermined value (the peripheral length of the secondary transfer roller 9), the image formation controller 307 causes the processing to go to S1427. On the other hand, when the margin amount T_margin is less than the predetermined value (the peripheral length of the secondary transfer roller 9), the image formation controller 307 causes the processing to go to S1431.

By the above, according to the embodiment 5, in the case where the interval in which the discharge processing of the secondary transfer roller 9 can be executed is ensured by the sum of the trailing end margin information and the sheet interval with use of the margin information on the trailing end of the page as the image information, the discharge processing is executed between the images. By this, it becomes possible to prevent the backside contamination while further suppressing the lowering in productivity.

As described above, according to the embodiment 5, it is possible to suppress the lowering in productivity during the double-sided printing.

### Another Embodiment

The present disclosure is capable of being realized by processing such that a program for realizing one or more functions of the above-described embodiments is supplied to a system or an apparatus through a network or a storage medium and then one or more processors in the system or the apparatus reads are executes the program. Further, the present disclosure is also capable of being realized by a circuit (for example, ASIC) for realizing the one or more functions.

According to the present disclosure, the lowering in productivity during the double-sided printing can be suppressed.

### OTHER EMBODIMENTS

The above-described embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray disk (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-112005, filed on Jul. 11, 2024, which is hereby incorporated by reference herein in its entirety.

What is claimed is:

1. An image forming apparatus comprising:
an image bearing member;
an intermediary transfer member onto which a toner image formed on the image bearing member is transferred;
a transfer member configured to transfer the toner image, transferred on the intermediary transfer member, onto a sheet, the transfer member forming a transfer nip between the intermediary transfer member and the transfer member;
an accommodating portion configured to accommodate the sheet;
a detecting portion configured to detect presence or absence of the sheet in the accommodating portion;
a double-sided conveying path through which the sheet which has a front surface on which an image is formed, and which is conveyed toward the transfer nip passes; and
a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member,
wherein the controller is capable of executing a first operation in which the back surface printing is performed with a first interval from the immediately-before printing and a second operation in which the back surface printing is performed with a second interval longer than the first interval from the immediately before printing,
wherein the controller is capable of executing the first operation in a case where a predetermined condition is not satisfied, and is capable of executing the second operation in a case where the predetermined condition is satisfied,
wherein the predetermined condition includes at least one of that an environmental temperature is a predetermined temperature or more, that a remaining lifetime of a developing device is less than a predetermined value, that a user designates the second operation, that an image density in the immediately-before printing is a predetermined value or more, that an image in the immediately-before printing includes an image other than a text image, and that a maximum density of a part of a region in the immediately-before printing is a predetermined value or more, and
wherein in a case where detection that there is no sheet corresponding to the objective sheet is made by the detecting portion, the toner image formed by the second operation is transferred onto the re-conveying sheet.

2. An image forming apparatus comprising:
an image bearing member;
an intermediary transfer member onto which a toner image formed on the image bearing member is transferred;
a transfer member configured to transfer the toner image, transferred on the intermediary transfer member, onto a sheet, the transfer member forming a transfer nip between the intermediary transfer member and the transfer member;
an accommodating portion configured to accommodate the sheet;
a detecting portion configured to detect presence or absence of the sheet in the accommodating portion;
a double-sided conveying path through which the sheet which has a front surface on which an image is formed, and which is conveyed toward the transfer nip passes; and
a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member,
wherein the controller is capable of executing a first operation in which the back surface printing is performed with a first interval from the immediately-before printing and a second operation in which the back surface printing is performed with a second interval longer than the first interval from the immediately before printing,
wherein the controller is capable of executing the first operation in a case where a predetermined condition is not satisfied, and is capable of executing the second operation in a case where the predetermined condition is satisfied, and
wherein in a case where detection that there is no sheet corresponding to the objective sheet is made by the detecting portion, an amount of toner deposited on the transfer member by passing, through the transfer nip, of the toner image formed in the immediately-before printing is larger when the predetermined condition is satisfied than when the predetermined condition is not satisfied.

3. An image forming apparatus according to claim 1, wherein in a case where the second operation is executed, a cleaning operation of the transfer member is executable by the controller before the toner image formed in the back surface printing reaches the transfer nip.

4. An image forming apparatus according to claim 3, further comprising an applying portion configured to apply a voltage to the transfer member so that a potential difference generates between the transfer member and the intermediary transfer member,
wherein the controller controls the applying portion so as to execute a first applying operation and a second applying operation,
wherein toner charged to a normal polarity in the first applying operation receives an electrostatic force in a direction from the intermediary transfer member toward the transfer member, and toner charged to the normal polarity in the second applying operation receives an electrostatic force in a direction from the transfer member toward the intermediary transfer member, and
wherein in the case where the detection that there is no sheet controller to the objective sheet is made by the detecting portion, the second applying operation is executed when the toner image formed in the immediately-before printing passes through the transfer nip.

5. An image forming apparatus according to claim 4, wherein in the cleaning operation, the first applying operation is executed.

6. An image forming apparatus according to claim 1, wherein in a case where a margin between a trailing end of the toner image formed in the immediately-before printing and the objective sheet is longer than a predetermined length, even when the predetermined condition is satisfied, the controller is capable of executing the first operation in the case where the detection that there is no sheet is made by the detecting portion.

7. An image forming apparatus comprising:
an image bearing member;
an intermediary transfer member onto which a toner image formed on the image bearing member is transferred;
a transfer member configured to transfer the toner image, transferred on the intermediary transfer member, onto a sheet, the transfer member forming a transfer nip between the intermediary transfer member and the transfer member;
an accommodating portion configured to accommodate the sheet;
a detecting portion configured to detect presence or absence of the sheet in the accommodating portion;
a double-sided conveying path through which the sheet which has a front surface on which an image is formed, and which is conveyed toward the transfer nip passes; and
a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member,
wherein the controller is capable of executing a first operation in which the back surface printing is performed with a first interval from the immediately-before printing and a second operation in which the back surface printing is performed with a second interval longer than the first interval from the immediately before printing,
wherein the controller is capable of executing the first operation in a case where there is no designation of the second operation by a user, and is capable of executing the second operation in a case where there is the designation, and
wherein in a case where detection that there is no sheet corresponding to the objective sheet is made by the detecting portion, the toner image formed by the second operation is transferred onto the re-conveying sheet.

8. An image forming apparatus according to claim 7, wherein in a case where the second operation is executed, a cleaning operation of the transfer member is executable by the controller before the toner image formed in the back surface printing reaches the transfer nip.

9. An image forming apparatus according to claim 8, further comprising an applying portion configured to apply a voltage to the transfer member so that a potential difference generates between the transfer member and the intermediary transfer member,
wherein the controller controls the applying portion so as to execute a first applying operation and a second applying operation,
wherein toner charged to a normal polarity in the first applying operation receives an electrostatic force in a direction from the intermediary transfer member toward the transfer member, and toner charged to the normal polarity in the second applying operation receives an electrostatic force in a direction from the transfer member toward the intermediary transfer member, and
wherein in the case where the detection that there is no sheet controller to the objective sheet is made by the detecting portion, the second applying operation is executed when the toner image formed in the immediately-before printing passes through the transfer nip.

10. An image forming apparatus according to claim 9, wherein in the cleaning operation, the first applying operation is executed.

11. An image forming apparatus according to claim 7, wherein in a case where a margin between a trailing end of the toner image formed in the immediately-before printing and the objective sheet is longer than a predetermined length, even when the designation is made, the controller is capable of executing the first operation in the case where the detection that there is no sheet is made by the detecting portion.

12. An image forming apparatus comprising:
an image bearing member;
an intermediary transfer member onto which a toner image formed on the image bearing member is transferred;
a transfer member configured to transfer the toner image, transferred on the intermediary transfer member, onto a sheet, the transfer member forming a transfer nip between the intermediary transfer member and the transfer member;
an accommodating portion configured to accommodate the sheet;
a detecting portion configured to detect presence or absence of the sheet in the accommodating portion;
a double-sided conveying path through which the sheet which has a front surface on which an image is formed, and which is conveyed toward the transfer nip passes; and
a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member,
wherein the controller is capable of executing a first operation in which the back surface printing is performed with a first interval from the immediately-before printing and a second operation in which the back surface printing is performed with a second interval longer than the first interval from the immediately before printing,
wherein the controller is capable of executing the first operation in a case where there is no designation of the second operation by a user, and is capable of executing the second operation in a case where there is the designation, and
wherein in a case where detection that there is no sheet corresponding to the objective sheet is made by the detecting portion, an amount of toner deposited on the transfer member by passing, through the transfer nip, of the toner image formed in the immediately-before printing is larger when the designation is made than when the designation is not made.

13. An image forming apparatus according to claim 12, wherein an angle of rotation of the transfer member during passing of a portion corresponding to the second interval through the transfer nip is 360 degrees or more.

14. An image forming apparatus according to claim 13, wherein an angle of rotation of the transfer member during passing of a portion corresponding to the first interval through the transfer nip is less than 360 degrees.

15. An image forming apparatus comprising:
an image bearing member;
an intermediary transfer member onto which a toner image formed on the image bearing member is transferred;
a transfer member configured to transfer the toner image, transferred on the intermediary transfer member, onto a sheet, the transfer member forming a transfer nip between the intermediary transfer member and the transfer member;
an accommodating portion configured to accommodate the sheet;
a detecting portion configured to detect presence or absence of the sheet in the accommodating portion;
a double-sided conveying path through which the sheet which has a front surface on which an image is formed, and which is conveyed toward the transfer nip passes; and
a controller capable of executing back surface printing and immediately-before printing, wherein in the back surface printing, the toner image to be transferred onto a re-conveying sheet conveyed from the double-sided conveying path to the transfer nip is formed on the intermediary transfer member, and wherein in the immediate-before printing, the toner image to be transferred onto an objective sheet conveyed to the transfer nip immediately before the re-conveying sheet is conveyed to the transfer nip is formed on the intermediary transfer member,
wherein the controller is capable of executing a first operation in which the toner image formed in the back surface printing is transferred onto the re-conveying sheet, a second operation in which a cleaning operation of the transfer member is performed before the toner image formed in the back surface printing reaches the transfer nip and then the toner image formed in the back surface printing is transferred onto the re-conveying sheet, and a third operation in which the cleaning operation is performed after the toner image formed in the back surface printing passes through the transfer nip and then the toner image formed by executing the back surface printing again is transferred onto the re-conveying sheet,
wherein the controller is capable of executing the first operation in a case where a predetermined condition is not satisfied, and is capable of executing the second operation or the third operation depending on an interval between the immediately-before printing and the back surface printing in a case where the predetermined condition is satisfied,
wherein the predetermined condition includes at least one of that an environmental temperature is a predetermined temperature or more, that a remaining lifetime of a developing device is less than a predetermined value, that a user designates the second operation, that an image density in the immediately-before printing is a predetermined value or more, that an image in the immediately-before printing includes an image other than a text image, and that a maximum density of a part of a region in the immediately-before printing is a predetermined value or more, and
wherein in a case where detection that there is no sheet corresponding to the objective sheet is made by the detecting portion, the toner image formed in the immediately-before printing passes through the transfer nip before the first operation, the second operation, or the third operation.

16. An image forming apparatus according to claim 15, wherein in a case where the interval between the immediately-before printing and the back surface printing is an length in which the cleaning operation is executable, the second operation is executed, and in a case where the interval between the immediately-before printing and the back surface printing is not the length in which the cleaning operation is executable, the third operation is executed.

17. An image forming apparatus according to claim 15, further comprising an applying portion configured to apply a voltage to the transfer member so that a potential difference generates between the transfer member and the intermediary transfer member,
wherein the controller controls the applying portion so as to execute a first applying operation and a second applying operation,
wherein toner charged to a normal polarity in the first applying operation receives an electrostatic force in a direction from the intermediary transfer member toward the transfer member, and toner charged to the normal polarity in the second applying operation receives an electrostatic force in a direction from the transfer member toward the intermediary transfer member, and
wherein in the case where the detection that there is no sheet controller to the objective sheet is made by the detecting portion, the second applying operation is executed when the toner image formed in the immediately-before printing passes through the transfer nip.

18. An image forming apparatus according to claim 17, wherein the second applying operation is executed when the toner image formed in the back surface printing passes through the transfer nip before the cleaning operation in the third operation.

19. An image forming apparatus according to claim 17, wherein in the cleaning operation, the first applying operation is executed.

20. An image forming apparatus according to claim 15, wherein in a case where detection that there is no sheet controller to the objective sheet is made by the detecting portion, in a case where a margin between a trailing end of the toner image formed in the immediately-before printing and the objective sheet is longer than a predetermined length, even when the cleaning operation is not executable between the immediately-before printing and the back surface printing, the controller is capable of executing the second operation.
